(19) United States
(12) Patent Application Publication
(10) Pub. No.: US 2018/0182209 A1
(43) Pub. Date: Jun. 28, 2018

(54) PLAYER REVIEWABLE WAGERING SYSTEM

(71) Applicant: Gamblit Gaming, LLC, Glendale, CA (US)

(72) Inventors: Bryce Cire, Los Angeles, CA (US); Frank Cire, Pasadena, CA (US); Eric Meyerhofer, Pasadena, CA (US)

(21) Appl. No.: 15/834,006

(22) Filed: Dec. 6, 2017

Related U.S. Application Data
(60) Provisional application No. 62/438,395, filed on Dec. 22, 2016.

(51) Int. Cl. G07F 17/32; G07F 17/34

(52) U.S. Cl. CPC G07F 17/3244; G07F 17/3286; G07F 17/3213; G07F 17/34; G07F 17/3206

(57) ABSTRACT

A player reviewable wagering system is disclosed. The player reviewable wagering system includes an interactive controller constructed to provide an interactive application to a player, detect an event transition in the interactive application associated with a transition to a node of the interactive application, and communicate the base node and the event transition to a process controller. The process controller communicates with the interactive controller and the process controller is constructed to receive the event transition and the base node, store the base node and the event transition in a datastore, generate a wagering session review presentation of the base node and the event transition and display the wagering session review presentation to the player.

### CROSS REFERENCE TO RELATED APPLICATIONS

This application claims the benefit of U.S. Provisional Patent Application No. 62/438,395, filed Dec. 22, 2016, the contents of which are incorporated by reference herein.

### FIELD OF THE INVENTION

Embodiments of the invention are generally related to data processing systems. More particularly, embodiments of the invention relate to data processing systems that implement wagering processes.

### BACKGROUND

The gambling industry has traditionally developed simple gambling games having simple randomized features that are implementable on conventional electronic gambling machines (EGMs). However, in order to implement a complex gambling, data processing systems capable of implementing complex randomized features are needed. Various aspects of embodiments of the invention meet such a need.

### SUMMARY OF THE INVENTION

Systems and methods in accordance with embodiments of the invention provide a communication and data processing system constructed for a player reviewable wagering system.

In an embodiment, a player reviewable electronic gaming machine, includes an interactive controller that provides a presentation of a skill proposition of an interactive application to a player, detects an event transition in the interactive application to an outcome node and communicates data of the outcome node to a process controller. The process controller communicates with the interactive controller, receives the data of the outcome node, stores the data of the outcome node in a datastore, generates a wagering session review presentation of the outcome node using the data of the outcome node stored in the datastore; and displays the wagering session review presentation to the player.

In another embodiment, the interactive controller and the process controller are constructed from a same device.

In many embodiments, the player reviewable electronic gaming machine includes an enclosure constructed to mount a player input device operatively connected to the interactive controller, a player output device operatively connected to the interactive controller, a credit input device operatively connected to the process controller, and a credit output device operatively connected to the process controller.

In some embodiments, the player reviewable electronic gaming machine includes a random number generator and the process controller is further constructed to communicate with the credit input device to receive credit data, credit a credit meter with credits based on the credit data, generate a chance-based outcome of credits based on a random element generated by the random number generator, generate a complex wager outcome using the data of the outcome node and the chance-based outcome, update the credit meter on the basis of the complex wager outcome, and communicate with the credit output device to generate a credit output based on credits transferred off of the credit meter. The interactive controller is further constructed to detect player interactions with interactive elements of the interactive application using the player input device, and detect the event transition associated with the outcome node based on the player interactions.

In an embodiment, a player reviewable electronic gaming machine, has a processor and a machine-readable storage medium operatively connected to the processor. The machine-readable storage medium stores executable instructions that when executed by the processor cause the processor to provide a presentation of a skill proposition of an interactive application to a player, detect an event transition in the interactive application to an outcome node, store the data of the outcome node in a datastore, generate a wagering session review presentation of the outcome node using the data of the outcome node stored in the datastore, and display the wagering session review presentation to the player.

In an embodiment of the invention, a process controller operates as an interface between an interactive controller that detects event transitions between nodes of a game space and a wager subcontroller that generates chance-based outcomes that are associated with base nodes of the game space. By virtue of this feature, the wager subcontroller is isolated from the interactive controller allowing the interactive controller to operate in an unregulated environment while allowing the wager subcontroller to operate in a regulated environment, thus providing for more efficient management of the operations of such a system.

In another embodiment of the invention, a single wager subcontroller may provide services to two or more interactive controllers, thus allowing a player reviewable wagering system to operate more efficiently over a large range of scaling.

In another embodiment of the invention, multiple types of interactive controllers using different operating systems may be interfaced to a single type of process controller without requiring customization of the process controller and/or the wager subcontroller, thus improving the efficiency of the process controller and/or the wager subcontroller by reducing complexity associated with maintaining separate process controllers and/or wager subcontrollers for each type of interactive controller.

In another embodiment of the invention, an interactive controller may be provided as a player device under control of a player while maintaining the process controller in an environment under the control of a regulated operator of wagering equipment, thus providing for a more economical system as the regulated operator need not expend capital to purchase interactive controllers.

In another embodiment of the invention, data communicated between the controllers may be encrypted to increase security of the player reviewable wagering system.

In another embodiment of the invention, a process controller isolates complex wagering proposition logic and skill proposition logic as unregulated logic from a regulated wager subcontroller, thus allowing errors in the skill proposition logic and/or complex wagering proposition logic to be corrected, new skill proposition logic and/or complex wagering proposition logic to be used, or modifications to be made to the skill proposition logic and/or complex wagering proposition logic without a need for time-consuming regulatory approval.

In another embodiment of the invention, an interactive application may require extensive processing resources from an interactive controller leaving few processing resources for the functions performed by a process controller and/or a wager subcontroller. By virtue of an architecture of some embodiments of the invention, processing loads may be distributed across multiple devices such that operations of the interactive controller may be dedicated to an interactive application and the processes of the process controller and/or wager subcontroller are not burdened by the requirements of the interactive application.

In another embodiment of the invention, a player reviewable wagering system operates with its components being distributed across multiple devices. These devices can be connected by communication channels including, but not limited to, local area networks, wide area networks, local communication buses, and/or the like. The devices may communicate using various types of protocols, including but not limited to, networking protocols, device-to-device communications protocols, and the like. In many such embodiments, components of a player reviewable wagering system are distributed in close proximity to each other and communicate using a local area network and/or a communication bus. In several embodiments, an interactive controller and a process controller of a player reviewable wagering system are in a common location. In some embodiments, a process controller communicates with an external interactive controller. In various embodiments, these multiple controllers and sub-controllers can be constructed from or configured using a single device or a plurality of devices such that a player reviewable wagering system is executed as a system in a virtualized space such as, but not limited to, where a wager subcontroller and a process controller are large scale centralized servers and are operatively connected to distributed interactive controllers via a wide area network such as the Internet or a local area network. In such embodiments, the components of a player reviewable wagering system may communicate using a networking protocol or other type of device-to-device communications protocol.

In another embodiment of the invention, an interactive controller is an interactive server acting as a host for managing head-to-head player interactions over a network of interactive sub-controllers connected to the interactive server using a communication link. The interactive server provides an environment where players can compete directly with one another and interact with other players.

### BRIEF DESCRIPTION OF THE DRAWINGS

FIG. 1 is a diagram of a structure of a player reviewable wagering system in accordance with various embodiments of the invention.

FIG. 2A is a diagram of an electronic gaming machine configuration of a player reviewable wagering system in accordance with various embodiments of the invention.

FIG. 2B is a diagram of a table electronic gaming machine configuration of a player reviewable wagering system in accordance with various embodiments of the invention.

FIG. 3 is a diagram of distributed player reviewable wagering systems in accordance with various embodiments of the invention.

FIGS. 4A and 4B are diagrams of a structure of an interactive controller of a player reviewable wagering system in accordance with various embodiments of the invention.

FIG. 5 is a diagram of a structure of a process controller of a player reviewable wagering system in accordance with various embodiments of the invention.

FIG. 6 is a diagram of a structure of a credit processing system of a player reviewable wagering system in accordance with various embodiments of the invention.

FIG. 7 is a diagram of a structure of a credit processing system in accordance with various embodiments of the invention.

FIG. 8A is a block diagram of a process of a player reviewable wagering system during a wagering session in accordance with various embodiments of the invention.

FIG. 8B is a block diagram of a complex wagering proposition of a player reviewable wagering system during a wagering session in accordance with various embodiments of the invention.

FIG. 8C is a diagram illustrating a complex wager outcome in accordance with various embodiments of the invention.

FIG. 9A is a state diagram of a complex wagering process in accordance with various embodiments of the invention.

FIG. 9B is another state diagram of a complex wagering process in accordance with various embodiments of the invention.

FIG. 9C is a sequence diagram of interactions between components of a player reviewable wagering system during a wagering session in accordance with various embodiments of the invention.

FIG. 10 is a state diagram of a wagering process in accordance with an embodiment of the invention.

FIG. 11 is a data flow diagram of a player dispute resolution process in accordance with an embodiment of the invention.

### DETAILED DESCRIPTION

An example conventional slot machine game is a mechanical 3 reel slot machine having 22 possible positions or symbols on each reel. In such a slot machine game, there are 22̂3, or 10,648, possible pays based on the combinations of the reel positions. Each time the slot machine is played, a single pay is determined from a single independent random event, namely the spinning of the mechanical reels. If such a 3 reel slot machine is implemented on a conventional electronic gaming machine having virtual video reels, each possible pay is explicitly enumerated in a paytable that is used to determine a pay as well as determine an animation sequence of the video virtual reels that corresponds to the pay. The combination of a pay and an associated reel animation sequence constitute a game feature. Such a paytable will have at least 10,648 locations, one position for each possible combination of the 3 reels, with each location representing a pay and a representation of the stopped position of the 3 reels. If digital storage of each pay requires 8 bytes of storage, such a paytable can be stored in approximately 83 kilobytes of digital memory (8 bytes of data for each game feature×10,648 possible pays/1024 Bytes per kilobyte). In operation, a single random number is determined, and that random number is used as an index into the paytable to select a game feature of a single pay and reel animation identifier from the 10,648 possible pays and reel animations. Accordingly, approximately 83 kilobytes of memory is needed to store the enumerated game features of a simple slot machine game having approximately 10 thousand game features on a conventional electronic gaming machine.

In accordance with various embodiments, a complex wagering process can be modeled using a multidimensional manifold or game space where each dimension of the game space is associated with a type of event transition of the complex wagering process. Such a complex wagering process will have a set of states or nodes within the game space. During the complex wagering process, the complex wagering process will transition through a subset of the set of nodes as player interactions with the complex wagering process are detected as events that cause event transitions. The subset of nodes that are transitioned to constitute a set of outcome nodes. Complex wagering processes implemented as described herein have sets of nodes and outcome nodes whose sizes are many orders of magnitude larger than a set of pays of a simple slot machine game. In an example embodiment, a complex wagering process includes a display where selectable chance-based outcomes are displayed to a player as a set of selectable nodes. The display includes 9 locations with each location having twenty-two possible chance-based outcomes. Such a complex wagering process display has 1,207,269,217,792, or over 1.2 trillion, possible nodes. If 8 bytes of digital memory are used to store each node, then a complete enumeration of all of nodes, as required using conventional electronic game machine architecture, would require 9.6 terabytes of memory storage. However, utilization of a player reviewable wagering system and wagering processes as described herein reduces storage memory requirements for such a complex wagering process to less than 1 megabyte. Such a reduction in memory requirements reduces the amount of physical and/or virtual memory needed to implement the complex wagering process, and also may reduce an amount of time needed to generate a complex wagering process display.

In another example embodiment, a complex wagering process has a game space with 17 dimensions and approximately 1,576,418,005,371,090,000,000, or over 1.5 sextillion nodes. Enumeration and storage of such a set of nodes for implementation of the complex wagering process on a conventional electronic gaming machine would require over 12.6 zettabytes of addressable memory storage which is simply not possible using conventional processor architecture; accordingly, such a complex wagering processes are simply not implementable using conventional electronic gaming machines. However, such complex wagering processes may be implemented on various embodiments of a player reviewable wagering system as described herein.

A player reviewable wagering system allows for the management of a complex wagering process for a set of players. In some embodiments of a player reviewable wagering system, an interactive application executed by an interactive controller provides a presentation of the complex wagering process to the set of players of the player reviewable wagering system. The interactive controller is operatively connected to a process controller that manages crediting and other administrative processes as well as generating a set of chance-based outcomes that are used in the complex wagering process. The interactive controller detects an outcome node based on state logic of the complex wagering process and detection of a set of player interaction events with interactive elements of the presentation of the complex wagering process. The outcome node is communicated by the interactive controller to the process controller and the process controller generates a complex wager outcome from the chance-based outcomes and the outcome node.

In some embodiments, the interactive controller also provides a wagering user interface that is used to receive commands and display data for a wagering process and wager outcome generated from the outcome node in accordance with a complex wagering proposition. The content of the wagering user interface is controlled by the process controller and includes content provided by the wager subcontroller and the interactive controller.

In various embodiments, an interactive controller provides a management user interface used to manage a player profile.

Many different types of interactive applications may be utilized with the player reviewable wagering system. In some embodiments, the interactive application reacts to the physical activity of a player. In these embodiments, the interactive application senses player interactions with the interactive application through a set of sensors that monitor the player's physical activities. Such sensors may include, but are not limited to, physiological sensors that monitor the physiology of the player, environmental sensors that monitor the physical environment of the interactive controller, accelerometers that monitor changes in motion of the interactive controller, and location sensors that monitor the location of the interactive controller such as global positioning sensors.

In some embodiments, the interactive application implements a skill-based game and interacts with the player by sensing skillful interactions with an interactive user interface generated by the interactive application.

In many embodiments, the interactive application generates various types of interactive elements in an interactive application environment. In some embodiments, these interactive elements are interactive application resources utilized within the interactive application environment to provide an interactive experience for a player.

In accordance with some embodiments, a chance-based outcome associated with the skill proposition can influence interactive elements in the interactive application environment such as, but not limited to, automatically providing a set of new interactive elements, automatically restoring a set of consumed interactive elements, automatically causing the loss of a set of interactive elements, and automatic restoration or placement of a set of fixed interactive elements.

In various embodiments, the wagers may be made using a set of credits.

In some embodiments, credits can be a set of credits that are purchased using, and redeemed in, a real world currency having a real world value.

In many embodiments, credits can be a set of credits in a virtual currency. Virtual currency is an alternate currency that can be acquired, purchased or transferred by or to a player, but does not necessarily directly correlate to a real world currency. In many such embodiments, credits in a virtual currency are allowed to be purchased using a real world currency but are prevented from being redeemed in a real world currency having a real world value.

In several embodiments, interaction with the interactive elements of the interactive application, application credits can be optionally consumed and/or accrued within the interactive application as a result of interaction with the interactive elements. Application credits can be in the form of, but not limited to, application environment credits, experience points, and points generally.

In various embodiments, application credits are awarded on the basis of skillful interactions with the interactive elements of a skill-based interactive application. The skill-based interactive application can have a set of skill metrics, embedded within a process controller and/or an interactive controller that provides the skill-based interactive application, that can be used to determine player performance against a set of skill propositions of the skill-based interactive application in accordance with a skill proposition.

In many embodiments, application credits can be used to purchase in-application items, including but not limited to, application interactive elements that have particular properties, power ups for existing items, and other item enhancements.

In some embodiments, application credits may be used to earn entrance into a sweepstakes drawing, to earn entrance in a tournament with prizes, to score in the tournament, and/or to participate and/or score in any other game event.

In several embodiments, application credits can be stored on a player-tracking card, voucher or in a network-based player tracking system where the application credits are attributed to a specific player.

In many embodiments, a complex wagering proposition includes a wager of application credits for payout of application credits, interactive application elements, and/or interactive application objects in accordance with the complex wagering proposition.

In a number of embodiments, a wager of an amount of credits results in a payout of application credits, interactive elements, and/or interactive application objects that have a credit value if cashed out.

In some embodiments, interactive application objects include in-application objects that may be utilized to enhance player interactions with the interactive application. Such objects include, but are not limited to, power-ups, enhanced in-application items, and the like. In some embodiments, the interactive application objects include objects that are detrimental to player interactions with the interactive application such as, but not limited to, obstructions in the interactive application space, a temporary handicap, an enhanced opponent, and the like.

In numerous embodiments, an interactive application command is an instruction by a process controller to an interactive controller and/or an interactive application of the interactive controller to modify a state of an interactive application or modify a set of interactive application resources or interactive elements. In some embodiments, the interactive application commands may be automatically generated by the process controller using a set of of a chance-based outcome and/or application environment variables. An interactive application command can be used by a process controller control many processes of an interactive application, such as, but not limited to, an causing an addition of a period of time available for a current interactive application session for the interactive application, an addition of a period of time available for a future player reviewable wagering system interactive application session or any other modification to the interactive application interactive elements that can be utilized during an interactive application session.

In some embodiments, asynchronous communications provided for by a player reviewable wagering system may reduce an amount of idle waiting time by an interactive controller of the player reviewable wagering system, thus increasing an amount of processing resources that the interactive controller may provide to an interactive application or other processes of the interactive controller. In many embodiments, asynchronous communications provided for by a player reviewable wagering system reduces an amount of idle waiting time by a process controller, thus increasing an amount of processing resources that the process controller may provide to generate chance-based outcomes, and other processes provided by the process controller.

In some embodiments, a wager subcontroller of a player reviewable wagering system may be operatively connected to a plurality of interactive controllers through a process controller and the asynchronous communications provided for by the process controllers allows the wager subcontroller to operate more efficiently by providing a set of chance-based outcomes to a larger number of interactive controllers than would be achievable without the process controller of the player reviewable wagering system.

In some embodiments, a player reviewable wagering system including a process controller operatively connected to a wager subcontroller and operatively connected to an interactive controller wherein the process controller provides for simplified communication protocols for communications of the interactive controller as the interactive controller may communicate interactions with an interactive application provided by the interactive controller to the process controller without regard to a nature of a complex wagering proposition.

In various embodiments, a player reviewable wagering system including a process controller operatively connected to a wager subcontroller and operatively connected to an interactive controller may provide for simplified communication protocols for communications of the wager subcontroller as the wager subcontroller may receive skill proposition requests and communicate generated skill propositions associated with chance-based outcomes without regard to a nature of an interactive application provided by the interactive controller.

In some embodiments, a player reviewable wagering system including a process controller operatively connecting a wager subcontroller to an interactive controller may provide for reduced processing requirement for the interactive controller by offloading the execution of a random number generator from the interactive controller to the process controller. In various such embodiments, additional processing resources may be made available to graphics processing or other processing intensive operations by the interactive controller because of the offloaded random number processing.

In various embodiments, a player reviewable wagering system including a process controller operatively connecting a wager subcontroller to an interactive controller provides for operation of the interactive controller in an unsecure location or manner, while providing for operation of the wager subcontroller in a secure location or manner.

In some embodiments, a player reviewable wagering system including a process controller operatively connecting a wager subcontroller to an interactive controller allows the skill wagering system to have regulated components coupled to unregulated components in a heterogeneous regulated environment. For example, in several such embodiments, the interactive controller may be a device that is not regulated by a wagering regulatory agency whereas the wager subcontroller is regulated by the wagering regulatory agency. A process controller of a player reviewable wagering system may provide for isolation of the processing of the interactive controller from the processing of the wager subcontroller. In such a heterogeneous regulatory environment, the process controller may or may not be itself a regulated by the wagering regulatory authority. In addition, components of an interactive application executed by the interactive controller may be either regulated or unregulated by the wagering regulatory agency.

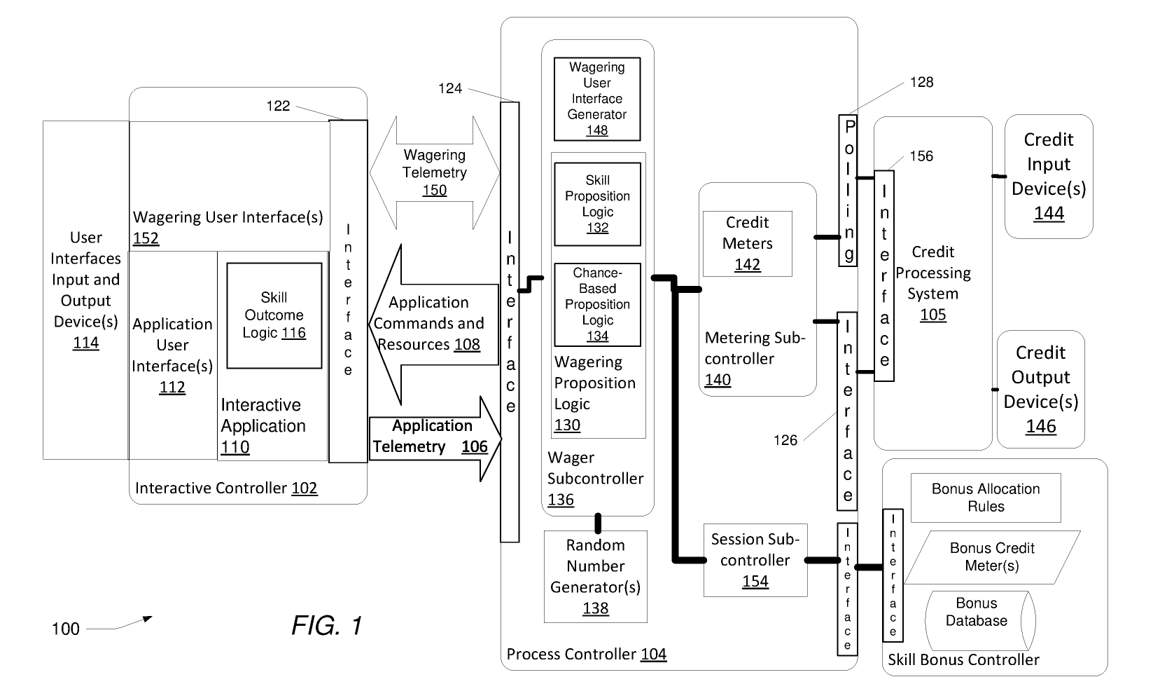

FIG. 1 is a diagram of a structure of a player reviewable wagering system in accordance with various embodiments of the invention. The player reviewable wagering system 100 includes an interactive controller 102, a process controller 104, and a credit processing system 105. The interactive controller 102 is operatively connected to, and communicates with, the process controller 104. The process controller 104 is also operatively connected to, and communicates with, the credit processing system 105.

In various embodiments, the interactive controller 102 executes an interactive application 110 and provides a set of user interface input and output devices 114 so that a set of players can interact with the interactive application 110. In various embodiments, user interface input devices include, but are not limited to: buttons or keys; keyboards; keypads; game controllers; joysticks; computer mice; track balls; track buttons; touch pads; touch screens; accelerometers; motion sensors; video input devices; microphones; and the like. In various embodiments, user interface output devices include, but are not limited to: audio output devices such as speakers, headphones, earbuds, and the like; visual output devices such as lights, video displays and the like; and tactile devices such as rumble pads, hepatic touch screens, buttons, keys and the like. The interactive controller 102 provides for player interactions with the interactive application 110 by executing the interactive application 110 that generates an application user interface 112 that utilizes the user interface input devices to detect player interactions with the interactive controller 102 and generates an interactive user interface that is presented to the player utilizing the user interface output devices.

In some embodiments, components of an interactive controller are housed in an enclosure such as a housing, cabinet, casing or the like. The enclosure further includes a set of player accessible openings or surfaces that constructed to mount the user interface input devices and/or the user interface output devices.

The interactive controller 102 is operatively connected to, and communicates with, the process controller 104. The interactive controller 102 receives application command and resource data 108 including skill proposition data, application command data, and resource data, from the process controller 104. Via the communication of the application command and resource data 108, the process controller 104 can control the operation of the interactive controller 102 by communicating control parameters to the interactive application 110 during the interactive application's execution by the interactive controller 102.

In some embodiments, during execution of the interactive application 110 by the interactive controller 102, the interactive controller 102 communicates, as application telemetry data 106, data of player interactions with a set of interactive elements of the application user interfaces 112 of the interactive application to the process controller 104. The application telemetry data 106 may include, but is not limited to, application environment variables that indicate a state of the interactive application 110, interactive controller data indicating a state of the interactive controller 102, player actions and interactions between a set of players and the interactive application 110 provided by the interactive controller 102, and utilization of interactive elements in the interactive application 110 by a set of players.

In some embodiments, the application telemetry 106 includes data of a set of event transitions associated with a set of nodes in a game space as detected by the interactive application 110 using skill outcome logic 116, the application command and resource data 108, and player interactions with one or more application user interfaces 112 of the interactive application.

In some embodiments, the interactive application 110 is a skill-based interactive application. In such embodiments, execution of the skill-based interactive application 110 by the interactive controller 102 is based on a set of players' skillful interaction with the interactive application 110, such as, but not limited to, the players' utilization of the interactive elements of the interactive application during the players' skillful interaction with the skill-based interactive application. In such an embodiment, the process controller 104 communicates with the interactive controller 102 in order to allow the coupling of the skill-based interactive application to chance-based outcomes generated in accordance with a complex wagering proposition of the wager subcontroller 136.

In some embodiments, the interactive application 110 uses skill proposition data, interactive application command data, and/or resource data included in the application commands and resources 108 to generate a skill proposition presented to a set of players as a set of application user interfaces 112 using a set of output devices of user interface input and output device(s) 114. The set of players skillfully interact with the set of application user interfaces 112 using a set of of input devices of the user interface input and output devices 114. The interactive application 110 detects an outcome node based on the skillful interactions of the set of players and communicates data of the detected outcome node to the process controller 104 as part of the application telemetry 106. In some embodiments, the interactive application 110 also communicates as part of the application telemetry data 106, data encoding the set of players' interactions with the interactive application 110.

In some embodiments, the skill outcome logic 116 and the skill proposition data included in the application commands and resources 108 are for a skill proposition for a set of players. The interactive application 110 detects a set of event transitions for a set of nodes of a game space based on the skill proposition and the set of players' skillful interactions with the interactive application. The transitioned to nodes are communicated by the interactive controller 102 to the process controller 104 included in the application telemetry 106 as a set of outcome nodes.

In some embodiments, the interactive controller 102 includes a set of sensors that sense various aspects of the physical environment of the interactive controller 102. Examples of sensors include, but are not limited to: global positioning sensors (GPSs) for sensing communications from a GPS system to detect a position or location of the interactive controller; temperature sensors; accelerometers; pressure sensors; and the like. Sensor telemetry data is communicated by the interactive controller to the process controller 104 as part of the application telemetry data 106. The process controller 104 receives the sensor telemetry data and uses the sensor telemetry data to make wagering decisions.

In many embodiments, the interactive controller 102 includes a set of wagering user interfaces 118 used to display wagering data, via a set of of the user interface input and output devices 114, to a set of players.

In various embodiments, an application control interface 122 resident in the interactive controller 102 provides an interface between the interactive controller 102 and the process controller 104.

In some embodiments, the application control interface 122 implements an interactive controller to process controller communication protocol employing an interprocess communication protocol so that the interactive controller and the process controller may be implemented on the same device. In operation, the application control interface 122 provides application programming interfaces that are used by the interactive application 110 of the interactive controller 102 to communicate outgoing data and receive incoming data by passing parameter data to another process or application.

In some embodiments, the application control interface 122 implements an interactive controller to process controller communication protocol employing an interdevice communication protocol so that the interactive controller and the process controller may be implemented on different devices. The interdevice protocol may utilize a wired communication bus or wireless connection as a physical layer.

In various embodiments, the application control interface 122 implements an interactive controller to process controller communication protocol employing a networking protocol so that the interactive controller and the process controller may be implemented on different devices connected by a network. The networking protocol may utilize a wired communication bus or wireless connection as a physical layer. In many such embodiments, the network includes a cellular telephone network or the like and the interactive controller is a mobile device such as a smartphone or other device capable of using the telephone network. During operation, the application control interface 122 communicates outgoing data to an external device by encoding the data into a signal and transmitting the signal to an external device. The application control interface receives incoming data from an external device by receiving a signal transmitted by the external device and decoding the signal to obtain the incoming data.

The process controller 104 provides an interface between a skill proposition resolved for a set of players when skillfully interacting with the interactive application 110 provided by the interactive controller 102, and a set of chance-based outcomes, provided in-part by a wager subcontroller 136.

In various embodiments, the process controller 104 includes a wager subcontroller 136 having a rule-based decision engine that receives application telemetry data 106 from the interactive controller 102. The rule-based decision engine has complex wagering proposition logic 130 including skill proposition logic 132 and complex wagering proposition logic 134. The decision engine uses the application telemetry data 106, along with complex wagering proposition logic 134, and a random element generated by a set of random number generators (RNGs) 138 to generate a set of chance-based outcomes of a complex wagering proposition.

In some embodiments, the complex wagering proposition logic 134 includes a set of paytables that may be used to generate a set of chance-based outcomes based on a set of random elements from a set of random number generators. A wager subcontroller uses the set of paytables to map the set of random elements to a set of chance-based outcomes. The set of paytables are used to implement a set of complex chance-based wagering propositions in conjunction with a set of random elements of the set of random number generators.

In an embodiment, the application telemetry data 106 used by the decision engine encodes data about the operation of the interactive application 110 executed by the interactive controller 102.

In some embodiments, the application telemetry data 106 encodes interactions of a player, such as a player's interaction with an interactive element of the interactive application 110.

In many embodiments, the application telemetry data 106 includes a state of the interactive application 110, such as values of variables that change as the interactive application 110 executes.

In several embodiments, the decision engine includes a set of rules as part of the complex wagering proposition logic 134 used by the decision engine 122 to determine how a chance-based outcome should generated. Each rule includes a set of variable values constituting a pattern that is to be matched by the wager subcontroller 136 using the decision engine to a set of variable values encoded in the application telemetry data 106. Each rule also includes a set of actions that are to be taken if the pattern is matched. Actions can include automatically generating the chance-based outcome in accordance with the complex wagering proposition logic 134 and a random element generated by a set of random number generators 138. During operation, the decision engine receives application telemetry data 106 from the interactive controller 102 via interface 160. The decision engine performs a matching process of matching the variable values encoded in the application telemetry data 106 to a set of variable patterns of a set of rules. If a match between the variable values and a pattern of a rule is detected, then the wagering controller 104 performs the action of the matched rule.

In some embodiments, the wager subcontroller 136 uses the chance-based outcome in conjunction with the application telemetry data 106 and skill proposition logic 132, to automatically generate application command and resource data 108 including skill proposition data of a complex wagering proposition that the process controller 104 communicates to the interactive controller 102 via interfaces 124 and 122.

In some embodiments, the decision engine includes a set of rules as part of skill proposition logic 132 used by the decision engine to automatically generate the application command and resource data 108 that is then communicated to the interactive controller 102. Each rule includes a set of variable values constituting a pattern that is to be matched to a set of variable values encoded in the application telemetry data 106 and the chance-based outcome. Each rule also includes a set of actions that are to be automatically taken by the wager subcontroller 136 if the pattern is matched. Actions can include automatically generating skill proposition data, interactive application command data, and/or resource data 108 and using the skill proposition data, interactive application command data, and/or resource data 108 to control the interactive controller 102 to affect execution of the interactive application 110 as described herein. In operation, wager subcontroller 104 uses the decision engine 122 to match the variable values encoded in the in the chance-based outcome data to a set of patterns of a set of rules of the skill proposition logic 132. If a match between the variable values and a pattern of a rule is found, then the process controller automatically performs the action of the matched rule. In some embodiments, the process controller 104 uses the application telemetry data 106 received from the interactive controller 102 in conjunction with the chance-based outcome to generate the skill proposition data, interactive application command data, and/or resource data 108.

The interactive controller receives the skill proposition data, interactive application command data, and resource data 108 and automatically uses the skill proposition data, interactive application command data, and/or resource data 108 to configure and command the processes of the interactive application 110.

In some embodiments, the interactive application 110 operates utilizing a scripting language. The interactive application 110 parses scripts written in the scripting language and executes commands encoded in the scripts and sets variable values as defined in the scripts. In operation of such embodiments, the process controller 104 automatically generates skill proposition data, interactive application command data, and/or resource data 108 in the form of scripts written in the scripting language that are communicated to the interactive controller 102 during execution of the interactive application 110. The interactive controller 102 receives the scripts and passes them to the interactive application 110. The interactive application 110 receives the scripts, parses the scripts and automatically executes the commands and sets the variable values as encoded in the scripts.

In many embodiments, the interactive application 110 automatically performs processes as instructed by commands communicated from the process controller 104. The commands command the interactive application 110 to perform specified operations such as executing specified commands and/or setting the values of variables utilized by the interactive application 110. In operation of such embodiments, the process controller 104 automatically generates commands that are encoded into the skill proposition data, interactive application command data, and/or resource data 108 that are communicated to the interactive controller 102. The interactive controller 102 passes the skill proposition data, interactive application command data, and/or resource data 108 to the interactive application 110. The interactive application parses the skill proposition data, interactive application command data, and/or resource data and automatically performs operations in accordance with the commands encoded in the skill proposition data, interactive application command data, and/or resource data 108.

In many embodiments, the process controller 104 includes a pseudo random or random element generator used to generate random elements that are used by the decision engine to generate portions of the skill proposition data, interactive application command data, and/or resource data 108.

In various embodiments, the process controller 104 includes a set of interfaces, 124, 126 and 128 that operatively connect the process controller 104 to a set of interactive controllers, such as interactive controller 102, and to a set of credit processing systems, such as credit processing system 105.

In some embodiments, a set of the process controller interfaces implement a process controller to device or server communication protocol employing an interprocess communication protocol so that the process controller and a set of of an interactive controller, a wager subcontroller, and/or a session sub-controller may be implemented on the same device. In operation, the process controller interfaces provide application programming interfaces or the like that are used by the process controller to communicate outgoing data and receive incoming data by passing parameter data to another process or application running on the same device.

In some embodiments, a set of the process controller interfaces implement a process controller communication protocol employing an interdevice communication protocol so that the process controller may be implemented on a device separate from the set of interactive controllers, the set of session sub-controllers and/or the set of wager subcontrollers. The interdevice protocol may utilize a wired communication bus or wireless connection as a physical layer. In various embodiments, a set of the process controller interfaces implement a process controller communication protocol employing a networking protocol so that the process controller may be operatively connected to the set of interactive controllers, the set of session sub-controllers, and/or the set of wager subcontrollers by a network. The networking protocol may utilize a wired communication bus or wireless connection as a physical layer. In many such embodiments, the network includes a cellular telephone network or the like and the set of interactive controllers include a mobile device such as a smartphone or other device capable of using the telephone network. During operation, the set of process controller interfaces communicate outgoing data to an external device or server by encoding the data into a signal and transmitting the signal to the external device or server. The set of process controller interfaces receive incoming data from an external device or server by receiving a signal transmitted by the external device or server and decoding the signal to obtain the incoming data.

In several embodiments, the wager subcontroller 136 is a controller for providing a set of chance-based outcomes in accordance with a set of complex wagering propositions provided by the player reviewable wagering system 100. Types of value of a wager used in a complex wagering proposition can be a set of several different types of values. Types of values of a wager can include, but are not limited to, a wager of an amount of credits corresponding to a real currency or a virtual currency, a wager of an amount of application credits earned through interaction with an interactive application, a wager of an amount of interactive elements of an interactive application, and a wager of an amount of objects used in an interactive application.

In various embodiments, an outcome node detected for a wager in accordance with a skill proposition can increase or decrease an amount of the type of value used in the wager, such as, but not limited to, increasing or decreasing an amount of credits for a wager of credits. In various embodiments, an outcome node detected for a wager in accordance with a skill proposition can increase or decrease an amount of a type of value that is different than a type of value of the wager, such as, but not limited to, increasing an amount of an object of an interactive application for a wager of credits.

In many embodiments, the process controller 104 includes a set of random number generators (RNGs) 138 for generating random elements. The wager subcontroller uses the set of random elements along with the complex wagering proposition logic 130 to generate a set of chance-based outcomes in accordance with a chance-based of a complex wagering proposition.

In several embodiments, the process controller 104 includes a metering sub-controller 140 operatively connected to the credit processing system 105 via interfaces 126 and 128. The metering sub-controller 140 communicates with the credit processing system 105 to receive incoming credit data from the credit processing system 105. The metering sub-controller 140 uses the incoming credit data to transfer credits into the player reviewable wagering system and onto a set of credit meters 142. The metering sub-controller 140 communicates outgoing credit data to the credit processing system 105 to transfer credits off of the set of credit meters 142 and out of the player reviewable wagering system.

In several embodiments, during operation, the metering sub-controller 140 communicates with the credit processing system 105 to receive incoming credit data from the credit processing system 105 and adds credits onto the set of credit meters 110 at least partially on the basis of the incoming credit data. The set of random number generators 138 execute processes that generate random elements. The wager subcontroller 136 uses the complex wagering proposition logic 134 and the random elements to generate a set of chance-based outcomes of a complex wagering proposition. The wager subcontroller uses the chance-based outcome along with the skill proposition logic 132 to generate a skill proposition. The skill proposition is communicated by the process controller as part of the application command and resource data 108 to the interactive controller 102. The interactive application 110 uses the skill proposition data along with the skill outcome logic 116 to generate a presentation for the use including the set of user interfaces 112. A set of players interact with the set of application user interfaces 112 through the set of user interface input and output devices 114. The interactive application 110 detects an outcome node based on the interactions of the set of players and communicates data of the outcome node as part of the application telemetry data 106 to the process controller 104. The wagering sub controller 136 receives the outcome node data and instructs the metering sub-controller 140 to add credits to, or deduct credits from, the set of credit meters 110 based in part on the outcome node data. For example, in some embodiments, the metering sub-controller is instructed to add an amount of credits to a credit meter of the set of credit meters 110 when the outcome node indicates a win for a player associated with the credit meter. In various embodiments, the metering sub-controller is instructed to deduct an amount of credits from the credit meter when the outcome node indicates a loss for the player. At an end of a wagering session, the metering sub-controller 140 transfers credits off of the set of credit meters 110 and out of the player reviewable wagering system by communicating outgoing credit data to the credit processing system 105.

In many embodiments, the set of random number generators 138 generate random numbers by continuously generating pseudo random numbers using a pseudo random number generator. A most current pseudo random number is stored in a buffer thus constantly refreshing the buffer. In some embodiments, the buffer is refreshed at a rate exceeding 100 times per second. When the wager subcontroller 136 requests a random element, the wager subcontroller 136 receives the stored most current pseudo random number from the buffer. As timing between requests for a random element is not deterministic, the resulting output from the buffer is a random element such as a random number.

In many embodiments, the random element is used along with a paytable that the wager subcontroller selects from a set of paytables. The selected paytable includes a mapping of values in a range of values of the random element to specified multipliers to be applied to an amount of wagered credits to generate a chance-based outcome as an amount of credits to be added to a set of credit meters associated with the complex wagering proposition. A multiplier is selected from the paytable based on the random element and the selected multiplier is used along with an amount of credits wagered to generate a chance-based outcome as an amount of credits.

In some embodiments, a range of the value of a random element is mapped to a set of symbols representing a set of elements of a traditional complex wagering proposition. In several such embodiments, a random element is mapped to a virtual card of a deck of virtual cards. In another such embodiment, the random element is mapped to a virtual face of a virtual die. In yet another such embodiment, the random element is mapped to symbol of a virtual reel strip on a virtual reel slot machine. In yet another such embodiment, the random element is mapped to a pocket of a virtual roulette wheel. In some embodiments, two or more random elements are mapped to appropriate symbols to represent a completed complex wagering proposition. In one such embodiment, two or more random elements are mapped to faces of two or more virtual dice to simulate a random element generated by throwing two or more dice. In another such embodiment, multiple random elements are mapped to virtual cards from a virtual deck of cards without replacement. In yet another such embodiment, two or more random elements are mapped to two or more virtual reel strips to create stop positions for a virtual multi-reel slot machine.

In some embodiments, a wager subcontroller generates a chance-based outcome by executing proposition generation commands included in complex wagering proposition logic that define processes of a complex wagering proposition where the proposition generation commands are formatted in a scripting language. In operation, a decision engine of a process controller generates the proposition generation commands in the form of a script written in the scripting language. The script includes the proposition generation commands that describe how the wager subcontroller is to generate a chance-based outcome. The wager subcontroller parses the script encoded in the complex wagering proposition generation command data and executes the commands included in the script to generate the chance-based outcome.

In some embodiments, a wager subcontroller generates a chance-based outcome by executing proposition generation commands that define processes of the wagering user interface. In operation, a decision engine of a process controller generates the proposition generation commands. The wager subcontroller receives the proposition generation commands and executes the proposition generation commands to generate the chance-based outcome.

In various embodiments, the process controller 104 uses a rule-based decision engine to automatically generate an amount of application credits to award to a player based at least in part on the application telemetry data 106 including outcome node data and player interaction data with the interactive application 110 of the player reviewable wagering system. In numerous embodiments, the interactive application 110 is a skill-based interactive application and the application credits are awarded for a player's skillful interaction with the interactive application 110.

In some embodiments, the wager subcontroller 136 uses a wagering user interface generator 148 to automatically generate wagering telemetry data 150 on the basis of amounts of credits on the set of credit meters 142. The wagering telemetry data 150 is used by the process controller 104 to command the interactive controller 102 to automatically generate a set of wagering user interfaces 152 describing a state of wagered credit accumulation and loss for the player reviewable wagering system. When a player interacts with the set of wagering user interfaces 152, wagering user interface telemetry data 150 is generated by the set of wagering user interfaces 152 and communicated by the interactive controller 102 to the process controller 104 using interfaces 122 and 124.

In some embodiments, the wagering telemetry data 150 may include, but is not limited to, amounts of application credits and interactive elements earned, lost or accumulated through interaction with the interactive application 110, and credits, application credits and interactive elements amounts awarded, lost or accumulated.

In some embodiments, the skill proposition data, interactive application command data, and/or resource data 108 are communicated to the wagering user interface generator 148 and used as a partial basis for generation of the wagering telemetry data 150 communicated to the interactive controller 102.

In various embodiments, the wagering user interface generator 148 also receives chance-based outcome data that is used as a partial basis for generation of the wagering telemetry data 150 communicated to the interactive controller 102. In some embodiments, the chance-based outcome data also includes data about a set of states of a wager of the complex wagering proposition as generated by the wager subcontroller 136. In various such embodiments, the wagering user interface generator 148 generates a chance-based outcome generation process display and/or chance-based outcome state display using the set of states of the chance-based outcome. The chance-based outcome generation process display and/or chance-based outcome state display is included in the wagering telemetry data 150 that is communicated to the interactive controller 102. The complex wagering process display and/or wagering state display is automatically displayed by the interactive controller 102 using the set of wagering user interfaces 152. In other such embodiments, the set of states of the chance-based outcome are communicated to the interactive controller 102 and the interactive controller 102 is instructed to automatically generate the chance-based outcome generation process display and/or chance-based outcome state display of the set of wagering user interfaces 152 using the set of states of the chance-based outcome for display.

In some embodiments, the chance-based outcome includes state data about execution of a complex wagering proposition of the complex wagering proposition logic 134, including but not limited to a final state, intermediate state and/or beginning state of the complex wagering proposition. For example, in a complex wagering proposition that is based on slot machine math, the final state of the complex wagering proposition may be reel positions, in a complex wagering proposition that is based on roulette wheel math, the final state may be a pocket where a ball may have come to rest, in a complex wagering proposition that is a based on card math, the beginning, intermediate and final states may represent a sequence of cards being drawn from a deck of cards, etc.

In some embodiments, an interactive controller generates a wagering user interface by executing commands that define processes of the wagering user interface where the commands are formatted in a scripting language. In operation, a wagering user interface generator of a process controller generates commands in the form of a script written in the scripting language. The script includes commands that describe how the interactive controller is to display wager outcome data. The completed script is encoded as wagering telemetry data and communicated to the interactive controller by the process controller. The interactive controller receives the wagering telemetry data and parses the script encoded in the wagering telemetry data and executes the commands included in the script to generate the wagering user interface.

In many embodiments, an interactive controller generates a wagering user interface based on a document written in a document markup language that includes commands that define processes of the wagering user interface. In operation, a wagering user interface generator of a process controller generates a document composed in the document markup language. The document includes commands that describe how the interactive controller is to display wager outcome data. The completed document is encoded as wagering telemetry data and communicated to the interactive controller by the process controller. The interactive controller receives the wagering telemetry data and parses the document encoded in the wagering telemetry data and executes the commands encoded into the document to generate the wagering user interface.

In some embodiments, an interactive controller generates a wagering user interface by executing commands that define processes of the wagering user interface. In operation, a wagering user interface generator of a process controller generates the commands and encodes the commands into wagering telemetry data that is communicated to the interactive controller by the process controller. The interactive controller receives the wagering telemetry data and executes the commands encoded in the wagering telemetry data to generate the wagering user interface.

In various embodiments, an interactive controller includes a data store of graphic and audio display resources that the interactive controller uses to generate a wagering user interface as described herein.

In many embodiments, a process controller communicates graphic and audio display resources as part of wagering telemetry data to an interactive controller. The interactive controller uses the graphic and audio display resources to generate a wagering user interface as described herein.

In many embodiments, the process controller 104 may additionally include various audit logs and activity meters.

The process controller 104 can further operatively connect to a metering sub-controller to determine an amount of credit or interactive elements available and other wagering metrics of a complex wagering proposition. Thus, the process controller 104 may potentially affect an amount of credits in play for participation in the complex wagering proposition provided by the wager subcontroller. In some embodiments, the process controller 104 can also couple to a centralized server for exchanging various data related to players and the activities of the players during utilization of a player reviewable wagering system.

In a number of embodiments, communication of chance-based outcome generation commands between the wager subcontroller 136 and the process controller 104 can further be used to communicate various wagering control factors that the wager subcontroller uses as input. Examples of wagering control factors include, but are not limited to, an amount of credits, amount of application credits, amount of interactive elements, or amounts of objects consumed wager, and/or a player's election to enter a jackpot round.

In many embodiments, two or more players can be engaged in using the interactive application 110 executed by the interactive controller 102. In various embodiments, a player reviewable wagering system can include an interactive application 110 that provides a skill-based interactive application that includes head-to-head play between a single player and a computing device, between two or more players against one another, or multiple players playing against a computer device and/or each other. In some embodiments, the interactive application 110 can be a skill-based interactive application where the player is not skillfully playing against the computer or any other player such as skill-based interactive applications where the player is effectively skillfully playing against himself or herself.

In some embodiments, the process controller 104 utilizes the set of wagering user interfaces 152 to communicate certain interactive application data to the player, including but not limited to, club points, player status, control of the selection of choices, and messages which a player can find useful in order to adjust the interactive application experience or understand the wagering status of the player.

In some embodiments, the process controller 104 utilizes the set of wagering user interfaces 152 to communicate aspects of a complex wagering proposition to a player including, but not limited to, amount of credits, application credits, interactive elements, or objects in play, and amounts of credits, application credits, interactive elements, or objects available.

In a number of embodiments, the wager subcontroller 136 can accept complex wagering proposition factors including, but not limited to, modifications in the amount of credits, application credits, interactive elements, or objects wagered in each individual wagering event, entrance into a bonus round, and other factors. In several embodiments, the process controller 104 can communicate a number of factors back and forth to the wager subcontroller, such that an increase/decrease in a wagered amount can be related to the change in player profile of the player in the interactive application. In this manner, a player can control a wager amount per wagering event in accordance with the complex wagering proposition with the change mapping to a parameter or component that is applicable to the interactive application experience.

In some embodiments, the process controller 104 includes a session sub-controller 154 is used to regulate a player reviewable wagering system session.

In various embodiments, the session sub-controller 154 includes a set of session sub-controller interfaces that operatively connect the session sub-controller 154 to a set of wager subcontrollers, metering sub-controllers and pooled bet sub-controllers through their respective interfaces.

In some embodiments, a set of the session sub-controller interfaces implement a session sub-controller to device or server communication protocol employing an interprocess communication protocol so that the session sub-controller and a set of of an interactive controller, a wager subcontroller, and/or a process controller may be implemented on the same device. In operation, the session sub-controller interfaces provide application programming interfaces or the like that are used by the session sub-controller to communicate outgoing data and receive incoming data by passing parameter data to another process or application running on the same device.

In some embodiments, a set of the session sub-controller interfaces implement a session sub-controller communication protocol employing an interdevice communication protocol so that the session sub-controller may be implemented on a device separate from the set of interactive controllers, the set of process controllers and/or the set of wager subcontrollers. The interdevice protocol may utilize a wired communication bus or wireless connection as a physical layer. In various embodiments, a set of the session sub-controller interfaces implement a session sub-controller communication protocol employing a networking protocol so that the process session sub-controller may be operatively connected to the set of interactive controllers, the set of process controllers, and/or the set of wager subcontrollers by a network. The networking protocol may utilize a wired communication bus or wireless connection as a physical layer. In many such embodiments, the network includes a cellular telephone network or the like and the set of interactive controllers include a mobile device such as a smartphone or other device capable of using the telephone network. During operation, the set of session sub-controller interfaces communicate outgoing data to an external device or server by encoding the data into a signal and transmitting the signal to the external device or server. The set of session sub-controller interfaces receive incoming data from an external device or server by receiving a signal transmitted by the external device or server and decoding the signal to obtain the incoming data.

In various embodiments, components of the process controller 104 communicate session data to the session sub-controller. The session data may include, but is not limited to, player data, interactive controller data, pooled bet and side bet data, process controller data and wager subcontroller data used by the session sub-controller to regulate a player reviewable wagering system session.

In some embodiments, the session sub-controller 154 may also assert control of a player reviewable wagering system session by communicating session control data to components of the process controller 104. Such control may include, but is not limited to, commanding the process controller 104 to end a player reviewable wagering system session, initiating wagering in a player reviewable wagering system session, ending wagering in a player reviewable wagering system session but not ending a player's use of the interactive application portion of the player reviewable wagering system, and changing from real credit wagering in a player reviewable wagering system to virtual credit wagering, or vice versa.

In many embodiments, the session sub-controller 154 manages player profiles for a plurality of players. The session sub-controller 154 stores and manages data about players in order to provide authentication and authorization of players of the player reviewable wagering system 100. In some embodiments, the session sub-controller 154 also manages geolocation data to ensure that the player reviewable wagering system 100 is only used by players in jurisdictions were wagering is approved. In various embodiments, the session sub-controller 154 stores application credits that are associated with the player's use of the interactive application of the player reviewable wagering system 100.

In some embodiments, the session sub-controller 154 communicates player and session management data to the player using a management user interface (not shown) of the interactive controller. The player interacts with the management user interface and the management user interface generates management telemetry data that is communicated to the session sub-controller 154 via interfaces 122 and 124.

In some embodiments, the wager subcontroller 136 communicates wagering session data to the session sub-controller 154. In various embodiments, the session sub-controller communicates wagering session control data to the wager subcontroller 136.

In many embodiments, a player reviewable wagering system includes a skill bonus controller operatively connected to a process controller 104 via a set of interfaces. The skill bonus controller includes bonus outcome allocation rules for allocating a bonus outcome of credits to a player when the process controller 104 requests that the bonus outcome be generated. The skill bonus controller further includes a set of skill bonus pool credit meters for storing data about a set of pools of bonus credits that are available to provide to player as a bonus outcome. The skill bonus controller further includes a database for storing data about promotion pools of credits. In some embodiments, the skill bonus controller supports a plurality of types of skill games provided by a set of interactive applications, such as interactive application 110. In many embodiments, the database is used to store data of skill metrics of player's skillful play of a skill game provided the interactive application 110. In various embodiments, the database further stores data of wagering metrics of players' wagering when using the player reviewable wagering system.

In some embodiments, a process controller operates as an interface between an interactive controller and a wager subcontroller. By virtue of this construction, the wager subcontroller is isolated from the interactive controller allowing the interactive controller to operate in an unregulated environment while allowing the wager subcontroller to operate in a regulated environment.

In some embodiments, a single wager subcontroller may provide services to two or more interactive controllers and/or two or more process controllers, thus allowing a player reviewable wagering system to operate over a large range of scaling.

In various embodiments, multiple types of interactive controllers using different operating systems may be interfaced to a single type of process controller and/or wager subcontroller without requiring customization of the process controller and/or the wager subcontroller.

In many embodiments, an interactive controller may be provided as a player device under control of a player while maintaining the wager subcontroller in an environment under the control of a regulated operator of wagering equipment.

In several embodiments, data communicated between the controllers may be encrypted to increase security of the player reviewable wagering system.

In some embodiments, a process controller isolates complex wagering proposition logic and skill proposition logic as unregulated logic from a regulated wager subcontroller, thus allowing errors in the skill proposition logic and/or complex wagering proposition logic to be corrected, new skill proposition logic and/or complex wagering proposition logic to be used, or modifications to be made to the skill proposition logic and/or complex wagering proposition logic without a need for regulatory approval.

In various embodiments, an interactive application may require extensive processing resources from an interactive controller leaving few processing resources for the functions performed by a process controller and/or a wager subcontroller. By virtue of the architecture described herein, processing loads may be distributed across multiple devices such that operations of the interactive controller may be dedicated to the interactive application and the processes of the process controller and/or wager subcontroller are not burdened by the requirements of the interactive application.

In many embodiments, a player reviewable wagering system operates with its components being distributed across multiple devices. These devices can be connected by communication channels including, but not limited to, local area networks, wide area networks, local communication buses, and/or the like. The devices may communicate using various types of protocols, including but not limited to, networking protocols, device-to-device communications protocols, and the like.

In some embodiments, components of a player reviewable wagering system are distributed in close proximity to each other and communicate using a local area network and/or a communication bus. In several embodiments, an interactive controller and a process controller of a player reviewable wagering system are in a common location and communicate with an external wager subcontroller. In some embodiments, a process controller and a wager subcontroller of a player reviewable wagering system are in a common location and communicate with an external interactive controller. In many embodiments, an interactive controller, a process controller, and a wager subcontroller of a player reviewable wagering system are located in a common location. In some embodiments, a session sub-controller is located in a common location with a process controller and/or a wager subcontroller.

In various embodiments, these multiple devices can be constructed from or configured using a single device or a plurality of devices such that a player reviewable wagering system is executed as a system in a virtualized space such as, but not limited to, where a wager subcontroller and a process controller are large scale centralized servers in the cloud operatively connected to widely distributed interactive controllers via a wide area network such as the Internet or a local area network. In such embodiments, the components of a player reviewable wagering system may communicate using a networking protocol or other type of device-to-device communications protocol.

In some embodiments, a player reviewable wagering system is deployed over a local area network or a wide area network in an interactive configuration. An interactive configuration of a player reviewable wagering system includes an interactive controller operatively connected by a network to a process controller and a wager subcontroller.

In some embodiments, a player reviewable wagering system is deployed over a local area network or a wide area network in a mobile configuration. A mobile configuration of a player reviewable wagering system is useful for deployment over wireless communication network, such as a wireless local area network or a wireless telecommunications network. A mobile configuration of a player reviewable wagering system includes an interactive controller operatively connected by a wireless network to a process controller and a wager subcontroller.

In several embodiments, a centralized process controller is operatively connected to a set of interactive controllers and a set of wager subcontrollers using a communication link. The centralized process controller can perform the functionality of a process controller across various player reviewable wagering systems.

In numerous embodiments, an interactive application server provides a host for managing head-to-head play operating over a network of interactive controllers connected to the interactive application server using a communication link. The interactive application server provides an environment where players can compete directly with one another and interact with other players.

In many embodiments, the credit processing system 105 operatively connects to a set of credit input devices for generating incoming credit data from a credit input. Credit inputs can include, but are not limited to, credit items used to transfer credits. The incoming credit data are communicated by the credit processing system 105 to the metering sub-controller 140. In various embodiments, the set of credit input devices and their corresponding credit items include, but are not limited to: card readers for reading cards having magnetic stripes, RFID chips, smart chips, and the like; scanners for reading various types of printed indicia printed on to various types of media such as vouchers, coupons, TITO tickets, rewritable cards, or the like; and bill validator and/or coin validators that receive and validate paper and/or coin currency or tokens.

In various embodiments, the credit processing system 105 includes a set of credit output devices 146 for generating a credit output based on outgoing credit data 192 communicated from the wager subcontroller. Credit outputs can include, but are not limited to, credit items used to transfer credits. Types of credit output devices and their corresponding credit items may include, but are not limited to: writing devices that are used to write to cards having magnetic stripes, smart chips or the like; printers for printing various types of printed indicia onto vouchers, coupons, TITO tickets, vouchers, rewritable cards or the like; and bill and/or coin dispensers that output paper and/or coin currency or tokens.

In some embodiments, the credit processing system 105 is operatively connected to, and communicates with, a TITO controller or the like to determine incoming credit data representing amounts of credits to be transferred into the player reviewable wagering system and to generate outgoing credit data representing amounts of credits to be transferred out of the player reviewable wagering system. In operation, the credit processing system 105 communicates with a connected credit input device, such as a bill validator/ticket scanner, used to scan a credit input in the form of a TITO ticket having indicia of credit account data of a credit account of the TITO controller. The credit processing system 105 communicates the credit account data to the TITO controller. The TITO controller uses the credit account data to determine an amount of credits to transfer to the credit processing system 105, and thus to the metering sub-controller 140 of the process controller 104. The TITO controller communicates the amount of credits to the credit processing system 105. The credit processing system 105 communicates the amount of credits as incoming credit data to the metering sub-controller 140 and the metering sub-controller 140 credits a set of credit meters 142 with the amount of credits so that the credits can be used when a player makes wagers using the player reviewable wagering system 100.

In many embodiments, the credit processing system 105 is operatively connected to a bill validator/ticket scanner as one of the set of credit input devices 144. The credit processing system 105 communicates with the bill validator/ticket scanner to scan currency used as a credit input to determine an amount of credits as incoming credit data to transfer credit to a set of credit meters 110 associated with a set of players. The skill metering sub-controller 140 credits the set of credit meters 110 with the amount of credits so that the credits can be used when a player makes wagers using the player reviewable wagering system 100.

In some embodiments, the credit processing system 105 can use a TITO controller along with a ticket or voucher printer as one of the set of credit output devices 146 to generate a TITO ticket as a credit output for a player. In operation, the credit processing system 105 communicates, as outgoing credit data, data of an amount of credits to be credited to a credit account on the TITO controller. The TITO controller receives the amount of credits and creates the credit account and credits the credit account with the amount of credits. The TITO controller generates credit account data for the credit account and communicates the credit account data to the credit processing system 105. The credit processing system 105 uses the ticket or voucher printer to print indicia of the credit account data onto a TITO ticket or voucher as a credit output.

In various embodiments, a credit processing interface 156 resident in the credit processing system 105 provides an interface between the credit processing system 156 and the process controller 104.

In some embodiments, the application control interface 122 implements a credit processing system to process controller communication protocol employing an interprocess communication protocol so that the interactive controller 104 and the credit processing system 105 may be implemented on the same device. In operation, the credit processing interface 156 provides application programming interfaces that are used by the credit processing system 105 to communicate outgoing data and receive incoming data by passing parameter data to another process or application.

In some embodiments, the credit processing interface 156 implements an interactive controller to credit processing system communication protocol employing an interdevice communication protocol so that the interactive controller and the credit processing system may be implemented on different devices. The interdevice protocol may utilize a wired communication bus or wireless connection as a physical layer.

In various embodiments, the credit processing interface 156 implements an interactive controller to credit processing system communication protocol employing a networking protocol so that the interactive controller 104 and the credit processing system 105 may be implemented on different devices connected by a network. The networking protocol may utilize a wired communication bus or wireless connection as a physical layer. During operation, the credit processing interface 156 communicates outgoing data to an external device by encoding the data into a signal and transmitting the signal to an external device. The application control interface receives incoming data from an external device by receiving a signal transmitted by the external device and decoding the signal to obtain the incoming data.

In various embodiments, the credit processing system 105 provides an interface to an electronic payment management system (not shown) such as an electronic wallet or the like. The electronic payment system provides credit account data that is used for generating incoming credit data as a credit input and outgoing credit data as a credit output.

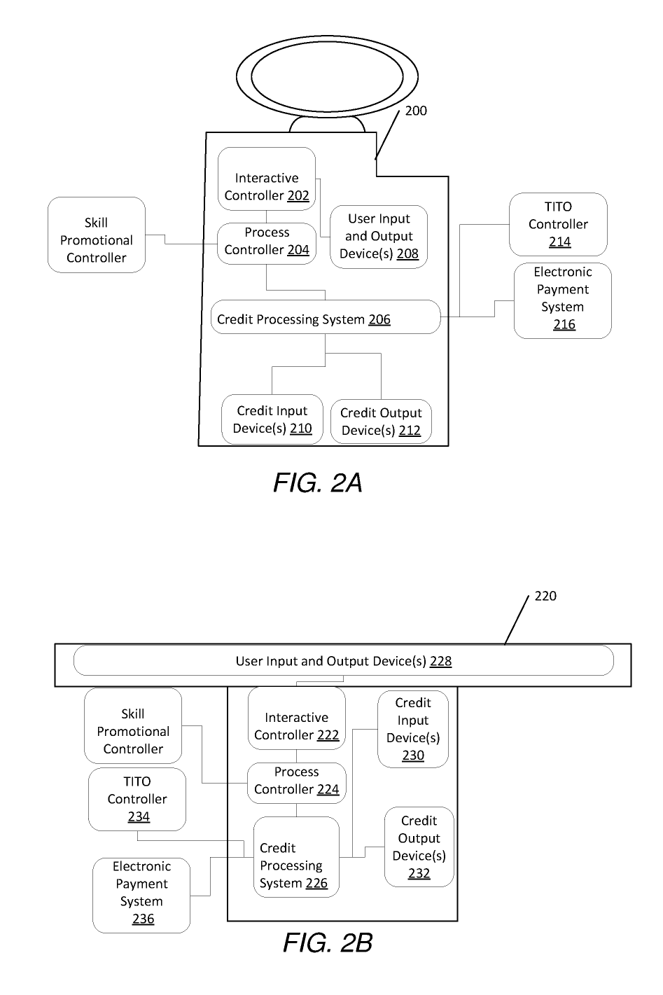

FIG. 2A is a diagram of an electronic gaming machine configuration of a player reviewable wagering system in accordance with various embodiments of the invention. Electronic gaming machine configurations of a player reviewable wagering system include, but are not limited to, electronic gaming machines such as slot machines, table games, video arcade consoles and the like. An electronic gaming machine configuration of a player reviewable wagering system 200 includes an interactive controller 202, a process controller 204 and a credit processing system 206 contained in an enclosure such as a housing, cabinet, casing or the like. The enclosure may further include a set of player accessible openings or surfaces that may be used to mount a set of player accessible player input devices and a set of player accessible player output devices 208, a set of player accessible credit input devices 210 and a set of player accessible credit output devices 212. The interactive controller 202 communicates with the player input devices to detect player interactions with the player reviewable wagering system and commands and controls the player output devices to provide a user interface to a set of players of the player reviewable wagering system as described herein. The process controller 204 communicates with the credit processing system 206 or player credit processing devices 210 and 212 to transfer credits into and out of the player reviewable wagering system as described herein.

In many embodiments, the process controller 204 is operatively connected to an external session sub-controller (not shown). The session sub-controller may provide session control for a wagering session or may provide services for management of a player account for the storage of player points, application credits and the like.

In various embodiments, the process controller 204 is operatively connected to the credit processing system 206. In many embodiments, the credit processing system 206 is operatively connected to a set of credit input devices 210 for generating incoming credit data from a credit input as described herein. The incoming credit data are communicated to the process controller 204. In various embodiments, the set of credit input devices and their corresponding credit items include, but are not limited to: card readers for reading cards having magnetic stripes, RFID chips, smart chips, and the like; scanners for reading various types of printed indicia printed on to various types of media such as vouchers, coupons, TITO tickets, rewritable cards, or the like; and bill validators and/or coin validators that receive and validate paper and/or coin currency or tokens.

In various embodiments, the credit processing system 206 is operatively connected to the set of credit output devices 212 for generating a credit output based on outgoing credit data communicated from the process controller 204. Credit outputs can include, but are not limited to, credit items used to transfer credits. Types of credit output devices and their corresponding credit items may include, but are not limited to: writing devices that are used to write to cards having magnetic stripes, smart chips or the like; printers for printing various types of printed indicia onto vouchers, coupons, TITO tickets, vouchers, rewritable cards or the like; and bill and/or coin dispensers that output paper and/or coin currency or tokens.

In some embodiments, the credit processing system 206 is operatively connected to, and communicates with, a TITO controller 214 or the like to determine incoming credit data representing amounts of credits to be transferred into the player reviewable wagering system 200 and to generate outgoing credit data representing amounts of credits to be transferred out of the player reviewable wagering system 200. In operation, the credit processing system 206 communicates with one of the set of connected credit input devices 210, such as a bill validator/ticket scanner, used to scan a credit input in the form of a TITO ticket having indicia of credit account data of a credit account of the TITO controller 214. The credit processing system 206 communicates the credit account data to the TITO controller 214. The TITO controller 214 uses the credit account data to generate an amount of credits to transfer to the credit processing system 206 of the player reviewable wagering system 200. The TITO controller 214 communicates the amount of credits to the credit processing system 206. The credit processing system 206 communicates the amount of credits as incoming credit data to the process controller 204 which credits a set of credit meters with the amount of credits so that the credits can be used when a player makes wagers using the player reviewable wagering system 200.

In many embodiments, the credit processing system 206 includes a bill validator/ticket scanner as one of the set of credit input devices 210. The credit processing system 206 communicates with the bill validator/ticket scanner to scan currency used as a credit input to determine an amount of credits as incoming credit data to transfer credit to a set of credit meters associated with a set of players. The process controller 204 credits the set of credit meters with the amount of credits so that the credits can be used when a player makes wagers using the player reviewable wagering system 200.

In some embodiments, the credit processing system 206 can use the TITO controller 214 along with a ticket or voucher printer as one of the set of credit output devices 212 to generate a TITO ticket as a credit output for a player. In operation, the credit processing system 206 communicates, as outgoing credit data, data of an amount of credits to be credited to a credit account on the TITO controller 214. The TITO controller 214 receives the amount of credits and creates the credit account and credits the credit account with the amount of credits. The TITO controller 214 generates credit account data for the credit account and communicates the credit account data to the credit processing system 206. The credit processing system 206 uses the ticket or voucher printer to print indicia of the credit account data onto a TITO ticket as a credit output.

In various embodiments, the credit processing system 206 provides an interface to an electronic payment system 216 such an electronic wallet or the like. The electronic payment system 216 provides credit account data that is used for generating incoming credit data as a credit input and outgoing credit data as a credit output.

In some embodiments, the process controller 204 is operatively connected to a central determination controller (not shown). In operation, when a wager subcontroller of the process controller 204 needs to generate a chance-based outcome, the wager subcontroller communicates a request to the central determination controller for the chance-based outcome. The central determination controller receives the chance-based outcome request and generates a chance-based outcome in response to the random element request. The central determination controller communicates data of the chance-based outcome to the process controller 204. The processing controller 204 receives the data of the chance-based outcome and utilizes the chance-based outcome as described herein. In some embodiments, the chance-based outcome is drawn from a pool of pre-determined random chance-based outcome. In some embodiments, the chance-based outcome is a chance-based outcome determined by a pari-mutuel controller.

In various embodiments, the complex wagering process controller 204 may be operatively connected to a skill bonus controller along with a set of other process controllers of a set of other player reviewable wagering systems. The skill bonus controller provides services for the collection and provision of credits used by the process controller 204 to provide chance-based outcomes that have a bonus pooling component.

FIG. 2B is a diagram of multiplayer electronic gaming machine configuration of a player reviewable wagering system in accordance with various embodiments of the invention. Types of a multiplayer electronic gaming machine configuration a player reviewable wagering system include, but are not limited to, multiplayer electronic gaming machines, multiplayer slot machines, multiplayer table gaming devices, multi player video arcade consoles and the like. A multiplayer electronic gaming machine configuration of a player reviewable wagering system 220 includes an interactive controller 222, a process controller 224 and a credit processing system 226 contained in an enclosure such as a housing, cabinet, casing or the like. The enclosure may further include a set of player accessible openings or surfaces that may be used to mount a set of player accessible player input devices and player output devices 228, a set of player accessible credit input devices 230 and a set of player accessible credit output devices 212.

In some embodiments, two or more sets of credit input devices and credit output devices are provided so that each player of the multiplayer electronic gaming machine configuration of a player reviewable wagering system 220 can have an associated set of credit input devices and credit output devices.

The interactive controller 222 communicates with the player input devices to detect player interactions with the player reviewable wagering system and commands and controls the player output devices to provide a user interface to a set of players of the player reviewable wagering system as described herein. The process controller 224 communicates with the credit processing system 226 or player credit processing devices 230 and 232 to transfer credits into and out of the player reviewable wagering system as described herein.

In many embodiments, the process controller 224 is operatively connected to an external session sub-controller (not shown). The session sub-controller may provide session control for a wagering session or may provide services for management of a player account for the storage of player points, application credits and the like.

In various embodiments, the process controller 224 is operatively connected to the credit processing system 226. In many embodiments, the credit processing system 226 is operatively connected to a set of credit input devices 230 for generating incoming credit data from a credit input as described herein. The incoming credit data are communicated to the process controller 224. In various embodiments, the set of credit input devices and their corresponding credit items include, but are not limited to: card readers for reading cards having magnetic stripes, RFID chips, smart chips, and the like; scanners for reading various types of printed indicia printed on to various types of media such as vouchers, coupons, TITO tickets, rewritable cards, or the like; and bill validators and/or coin validators that receive and validate paper and/or coin currency or tokens.

In various embodiments, the credit processing system 226 is operatively connected to the set of credit output devices 232 for generating a credit output based on outgoing credit data communicated from the process controller 224. Credit outputs can include, but are not limited to, credit items used to transfer credits. Types of credit output devices and their corresponding credit items may include, but are not limited to: writing devices that are used to write to cards having magnetic stripes, smart chips or the like; printers for printing various types of printed indicia onto vouchers, coupons, TITO tickets, vouchers, rewritable cards or the like; and bill and/or coin dispensers that output paper and/or coin currency or tokens.

In some embodiments, the credit processing system 226 is operatively connected to, and communicates with, a TITO controller 234 or the like to determine incoming credit data representing amounts of credits to be transferred into the player reviewable wagering system 220 and to generate outgoing credit data representing amounts of credits to be transferred out of the player reviewable wagering system 220. In operation, the credit processing system 226 communicates with one of the set of connected credit input devices 230, such as a bill validator/ticket scanner, used to scan a credit input in the form of a TITO ticket having indicia of credit account data of a credit account of the TITO controller 234. The credit processing system 226 communicates the credit account data to the TITO controller 234. The TITO controller 234 uses the credit account data to determine an amount of credits to transfer to the credit processing system 226 of the player reviewable wagering system 220. The TITO controller 234 communicates the amount of credits to the credit processing system 226. The credit processing system 226 communicates the amount of credits as incoming credit data to the process controller 224 which credits a set of credit meters with the amount of credits so that the credits can be used when a player makes wagers using the player reviewable wagering system 220.

In many embodiments, the credit processing system 226 includes a bill validator/ticket scanner as one of the set of credit input devices 230. The credit processing system 226 communicates with the bill validator/ticket scanner to scan currency used as a credit input to determine an amount of credits as incoming credit data to transfer credit to a set of credit meters associated with a set of players. The process controller 224 credits the set of credit meters with the amount of credits so that the credits can be used when a player makes wagers using the player reviewable wagering system 220.

In some embodiments, the credit processing system 226 can use the TITO controller 234 along with a ticket or voucher printer as one of the set of credit output devices 232 to generate a TITO ticket as a credit output for a player. In operation, the credit processing system 226 communicates, as outgoing credit data, data of an amount of credits to be credited to a credit account on the TITO controller 234. The TITO controller 234 receives the amount of credits and creates the credit account and credits the credit account with the amount of credits. The TITO controller 234 generates credit account data for the credit account and communicates the credit account data to the credit processing system 226. The credit processing system 226 uses the ticket or voucher printer to print indicia of the credit account data onto a TITO ticket as a credit output.

In various embodiments, the credit processing system 226 provides an interface to an electronic payment system 236 such an electronic wallet or the like. The electronic payment system 236 provides credit account data that is used for generating incoming credit data as a credit input and outgoing credit data as a credit output.

In some embodiments, the process controller 224 is operatively connected to a central determination controller (not shown). In operation, when a wager subcontroller of the process controller 224 needs to generate a chance-based outcome, the wager subcontroller communicates a request to the central determination controller for the chance-based outcome. The central determination controller receives the chance-based outcome request and generates a chance-based outcome in response to the chance-based outcome request. The central determination controller communicates data of the chance-based outcome to the process controller 224. The processing controller 224 receives the data of the chance-based outcome and utilizes the chance-based outcome as described herein. In some embodiments, the chance-based outcome is drawn from a pool of pre-determined chance-based outcomes.

In various embodiments, the complex wagering process controller 224 may be operatively connected to a skill bonus controller along with a set of other process controllers of a set of other player reviewable wagering systems. The skill bonus controller provides services for the collection and provision of credits used by the process controller 224 to provide chance-based outcomes that have a bonus pooling component.

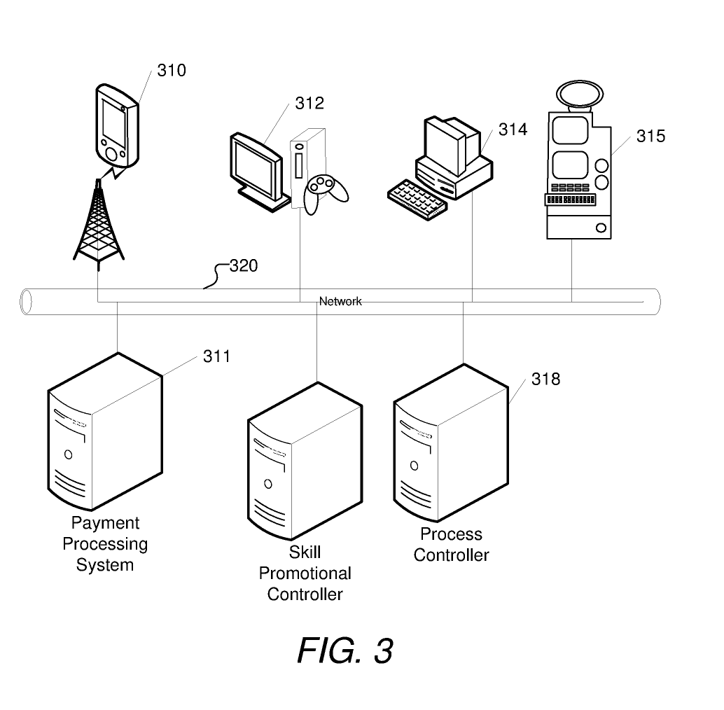

FIG. 3 is a diagram of distributed player reviewable wagering systems in accordance with various embodiments of the invention. An interactive controller, such as interactive controller 102 of FIG. 1, may be constructed from or configured using a set of processing devices that perform the operations of the interactive controller. An interactive controller in a distributed player reviewable wagering system may be constructed from or configured using any processing device having sufficient processing and communication capabilities that may be that perform the processes of an interactive controller in accordance with various embodiments of the invention. In some embodiments, the construction or configuration of the interactive controller may be achieved through the use of an application control interface, such as application control interface 122 of FIG. 1, and/or through the use of an interactive application, such as interactive application 110 of FIG. 1.

In some embodiments, an interactive controller may be constructed from or configured using an electronic gaming machine 315, such as a slot machine or the like. The electronic gaming machine 315 may be physically located in various types of gaming establishments.

In many embodiments, an interactive controller may be constructed from or configured using a portable device 310. The portable device 310 is a device that may wirelessly connect to a network. Examples of portable devices include, but are not limited to, a tablet computer, a personal digital assistant, and a smartphone.

In some embodiments, an interactive controller may be constructed from or configured using a gaming console 312.

In various embodiments, an interactive controller may be constructed from or configured using a personal computer 314.

In some embodiments, a set of processing devices, such as devices 310, 312, 314 and 315, may be used to construct a complete player reviewable wagering system and may be operatively connected using a communication link to a session and/or management controller.

Some player reviewable wagering systems in accordance with many embodiments of the invention can be distributed across a plurality of devices in various configurations. A set of interactive controllers of a distributed player reviewable wagering system, such as but not limited to, a mobile or wireless device 310, a gaming console 312, a personal computer 314, and an electronic gaming machine 315, are operatively connected with a process controller 318 of a distributed player reviewable wagering system using a communication link 320. Communication link 320 is a communications link that allows processing systems to communicate with each other and to share data. Embodiments of a communication link include, but are not limited to: a wired or wireless interdevice communication link; a serial or parallel interdevice communication bus; a wired or wireless network such as a Local Area Network (LAN), a Wide Area Network (WAN), or the link; or a wired or wireless communication network such as a wireless telecommunications network or plain old telephone system (POTS). In some embodiments, a set of processes of an interactive controller and a process controller as described herein are executed on the individual interactive controllers 310, 312, 314 and 315 while a set of processes of a process controller as described herein can be executed by the process controller 318.

In many embodiments, a distributed player reviewable wagering system and may be operatively connected using a communication link to a session controller (not shown), that performs the processes of a session controller as described herein.

In several embodiments, a distributed player reviewable wagering system and may be operatively connected using a communication link to credit processing system 311, that performs the processes of a set of credit processing systems as described herein.

In various embodiments, a set of distributed player reviewable wagering systems may be operatively connected to a skill bonus controller. The skill bonus controller provides services for the collection and provision of credits used to provide chance-based outcomes that have a bonus pooling component.

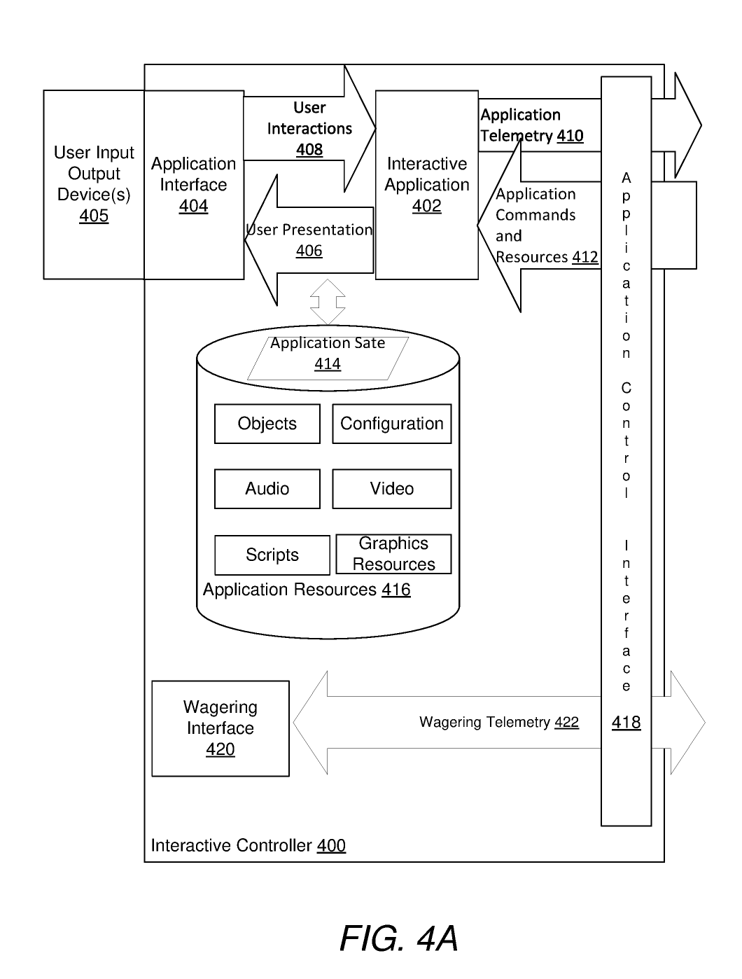

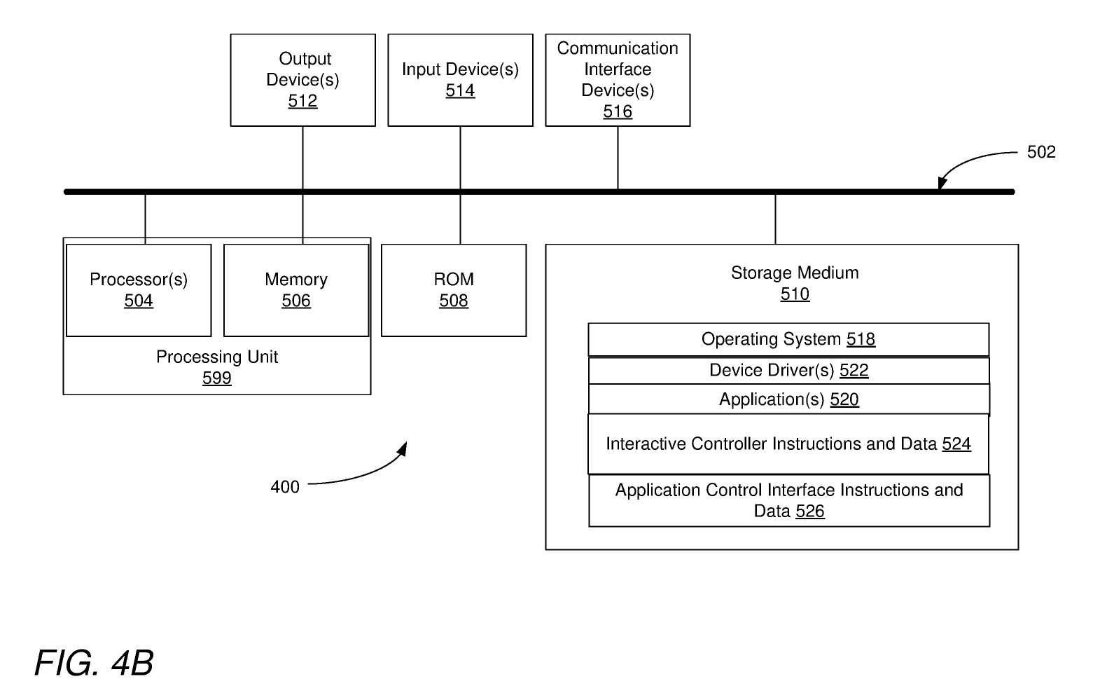

Referring now to FIG. 4A, an interactive controller 400, suitable for use as interactive controller 102 of FIG. 1, provides an execution environment for an interactive application 402 of a player reviewable wagering system. In several embodiments, an interactive controller 400 of a player reviewable wagering system provides an interactive application 402 that generates an application interface 404 for interaction with by a player. The interactive application 402 generates a player presentation 406 that is presented to the player through the application interface 404 using a set of player input and output devices 405. The player presentation 406 may include audio features, visual features or tactile features, or any combination of these features. In various embodiments, the application interface 404 utilizes a set of user interface input and output devices 405 so that a player can interact with the player presentation 406. In various embodiments, user interface input devices include, but are not limited to: buttons or keys; keyboards; keypads; game controllers; joysticks; computer mice; track balls; track buttons; touch pads; touch screens; accelerometers; motion sensors; video input devices; microphones; and the like. In various embodiments, user interface output devices include, but are not limited to: audio output devices such as speakers, headphones, earbuds, and the like; visual output devices such as lights, video displays and the like; and tactile devices such as rumble pads, hepatic touch screens, buttons, keys and the like. The player's interactions 408 are included by the interactive application 402 in application telemetry data 410 that is communicated by interactive controller 400 to various other components of a player reviewable wagering system as described herein. The interactive application 402 receives application commands and resources 412 communicated from various other components of a player reviewable wagering system as described herein. In some embodiments, the application telemetry data 410 may include player interactions with objects of the interactive application and an outcome node for a skill proposition presented to the player by the interactive application 402.

In some embodiments, various components of the interactive application 402 can read data from an application state 414 in order to provide a set of features of the interactive application. In various embodiments, components of the interactive application 402 can include, but are not limited to: a physics engine; a rules engine; an audio engine; a graphics engine and the like. The physics engine is used to simulate physical interactions between virtual objects in the interactive application 402. The rules engine implements the rules of the interactive application and a random number generator that may be used for influencing or generating certain variables and/or outcomes to provide a randomizing influence on the operations of the interactive application. The graphics engine is used to generate a visual representation of the interactive application state to the player. The audio engine is used to generate an audio representation of the interactive application state to the player.

During operation, the interactive application reads and writes application resources 416 stored on a data store of the interactive controller host. The application resources 416 may include objects having graphics and/or control logic used to provide application environment objects of the interactive application. In various embodiments, the resources may also include, but are not limited to, video files that are used to generate a portion of the player presentation 406; audio files used to generate music, sound effects, etc. within the interactive application; configuration files used to configure the features of the interactive application; scripts or other types of control code used to provide various features of the interactive application; and graphics resources such as textures, objects, etc. that are used by a graphics engine to render objects displayed in an interactive application.

In operation, components of the interactive application 402 read portions of the application state 414 and generate the player presentation 406 for the player that is presented to the player using the user interface 404. The player perceives the player presentation and provides player interactions 408 using the player input devices. The corresponding player interactions are received as player actions or inputs by various components of the interactive application 402. The interactive application 402 translates the player actions into interactions with the virtual objects of the application environment stored in the application state 414. Components of the interactive application use the player interactions with the virtual objects of the interactive application and the interactive application state 414 to update the application state 414 and update the player presentation 406 presented to the player. The process loops continuously while the player interacts with the interactive application of the player reviewable wagering system.

The interactive controller 400 provides a set of interfaces 418 between the interactive controller 400 and other components of a player reviewable wagering system, such as, but not limited to, a process controller. The interactive controller 400 and the other player reviewable wagering system components communicate with each other using the interface. The interface may be used to pass various types of data, and to communicate and receive messages, status data, commands and the like. In certain embodiments, the interactive controller 400 and a process controller communicate application commands and resources 412 and application telemetry data 410. In some embodiments, the communications include requests by the process controller that the interactive controller 400 update the application state 414 using data provided by the process controller.

In many embodiments, communications between a process controller and the interactive controller 400 includes a request that the interactive controller 400 update a set of resources 416 using data provided by the process controller. In a number of embodiments, the interactive controller 400 provides all or a portion of the application state to the process controller. In some embodiments, the interactive controller 400 may also provide data about a set of of the application resources 416 to the process controller. In some embodiments, the communication includes player interactions that the interactive controller 400 communicates to the process controller. The player interactions may be low level player interactions with the user interface 404, such as manipulation of an input device, or may be high level interactions with game objects as detected by the interactive application. The player interactions may also include resultant actions such as modifications to the application state 414 or game resources 416 resulting from the player's interactions taken in the player reviewable wagering system interactive application. In some embodiments, player interactions include, but are not limited to, actions taken by entities such as non-player characters (NPC) of the interactive application that act on behalf of or under the control of the player.

In various embodiments, the application commands and resources 412 include skill proposition application commands and/or resources used by the interactive application to generate a presentation of a skill proposition presented to a player and to detect a transition to an outcome node based on the player's skillful interaction with the presentation of the skill proposition.

In some embodiments, the interactive controller 400 includes a wagering user interface 420 used to provide player reviewable wagering system telemetry data 422 to and from the player. The player reviewable wagering system telemetry data 422 from the player reviewable wagering system includes, but is not limited to, data used by the player to configure credit, application credit and interactive element wagers, and data about the complex wagering proposition credits, application credits and interactive element wagers such as, but not limited to, credit, application credit and interactive element balances and credit, application credit and interactive element amounts wagered.

In some embodiments, the interactive controller includes a set of sensors (not shown). Such sensors may include, but are not limited to, physiological sensors that monitor the physiology of the player, environmental sensors that monitor the physical environment of the interactive controller, accelerometers that monitor changes in motion of the interactive controller, and location sensors that monitor the location of the interactive controller such as global positioning sensors (GPSs). The interactive controller 400 communicates sensor telemetry data to a set of components of the player reviewable wagering system.

Referring now to FIG. 4B, interactive controller 400 includes a bus 502 that provides an interface for a set of a set of processors 504, random access memory (RAM) 506, read only memory (ROM) 508, machine-readable storage medium 510, a set of player output devices 512, a set of player input devices 514, and a set of communication interface devices 516.

The set of processors 504 may take many forms, such as, but not limited to: a central processing unit (CPU); a multi-processor unit (MPU); an ARM processor; a controller; a programmable logic device; or the like.

In the example embodiment, the set of processors 504 and the random access memory (RAM) 506 form an interactive controller processing unit 599. In some embodiments, the interactive controller processing unit includes a set of processors operatively connected to a set of of a RAM, ROM, and machine-readable storage medium; the set of processors of the interactive controller processing unit receive instructions stored by the set of of a RAM, ROM, and machine-readable storage medium via a bus; and the set of processors execute the received instructions. In some embodiments, the interactive controller processing unit is an ASIC (Application-Specific Integrated Circuit). In some embodiments, the interactive controller processing unit is a SoC (System-on-Chip).

Examples of output devices 512 include, but are not limited to, display screens; light panels; and/or lighted displays. In accordance with particular embodiments, the set of processors 504 are operatively connected to audio output devices such as, but not limited to: speakers; and/or sound amplifiers. In accordance with many of these embodiments, the set of processors 504 are operatively connected to tactile output devices like vibrators, and/or manipulators.

Examples of player input devices 514 include, but are not limited to: tactile devices including but not limited to, keyboards, keypads, foot pads, touch screens, and/or trackballs; non-contact devices such as audio input devices; motion sensors and motion capture devices that the interactive controller can use to receive inputs from a player when the player interacts with the interactive controller; physiological sensors that monitor the physiology of the player; environmental sensors that monitor the physical environment of the interactive controller; accelerometers that monitor changes in motion of the interactive controller; and location sensors that monitor the location of the interactive controller such as global positioning sensors.

The set of communication interface devices 516 provide a set of wired or wireless interfaces for communicating data and commands between the interactive controller 400 and other devices that may be included in a player reviewable wagering system. Such wired and wireless interfaces include, but are not limited to: a Universal Serial Bus (USB) interface; a Bluetooth interface; a Wi-Fi interface; an Ethernet interface; a Near Field Communication (NFC) interface; a plain old telephone system (POTS) interface, a cellular or satellite telephone network interface; and the like.

The machine-readable storage medium 510 stores machine-executable instructions for various components of the interactive controller, such as but not limited to: an operating system 518; a set of device drivers 522; a set of application programs 520 including but not limited to an interactive application; and player reviewable wagering system interactive controller instructions and data 524 for use by the set of processors 504 to provide the features of an interactive controller as described herein. In some embodiments, the machine-executable instructions further include application control interface/application control interface instructions and data 526 for use by the set of processors 504 to provide the features of an application control interface/application control interface as described herein.

In various embodiments, the machine-readable storage medium 510 is one of a (or a combination of two or more of) a hard drive, a flash drive, a DVD, a CD, a flash storage, a solid state drive, a ROM, an EIEPROM, and the like.

In operation, the machine-executable instructions are loaded into memory 506 from the machine-readable storage medium 510, the ROM 508 or any other storage location. The respective machine-executable instructions are accessed by the set of processors 504 via the bus 502, and then executed by the set of processors 504. Data used by the set of processors 504 are also stored in memory 506, and the set of processors 504 access such data during execution of the machine-executable instructions. Execution of the machine-executable instructions causes the set of processors 504 to control the interactive controller 400 to provide the features of a player reviewable wagering system interactive controller as described herein

Although the interactive controller is described herein as being constructed from or configured using a set of processors and instructions stored and executed by hardware components, the interactive controller can be constructed from or configured using only hardware components in accordance with other embodiments. In addition, although the storage medium 510 is described as being operatively connected to the set of processors through a bus, those skilled in the art of interactive controllers will understand that the storage medium can include removable media such as, but not limited to, a USB memory device, an optical CD ROM, magnetic media such as tape and disks. In some embodiments, the storage medium 510 can be accessed by the set of processors 504 through one of the communication interface devices 516 or using a communication link. Furthermore, any of the player input devices or player output devices can be operatively connected to the set of processors 504 via one of the communication interface devices 516 or using a communication link.

In some embodiments, the interactive controller 400 can be distributed across a plurality of different devices. In many such embodiments, an interactive controller of a player reviewable wagering system includes an interactive application server operatively connected to an interactive client using a communication link. The interactive application server and interactive application client cooperate to provide the features of an interactive controller as described herein.

In various embodiments, the interactive controller 400 may be used to construct other components of a player reviewable wagering system as described herein.

In some embodiments, components of an interactive controller and a process controller of a player reviewable wagering system may be constructed from or configured using a single device using processes that communicate using an interprocess communication protocol. In other such embodiments, the components of an interactive controller and a process controller of a player reviewable wagering system may communicate by passing messages, parameters or the like.

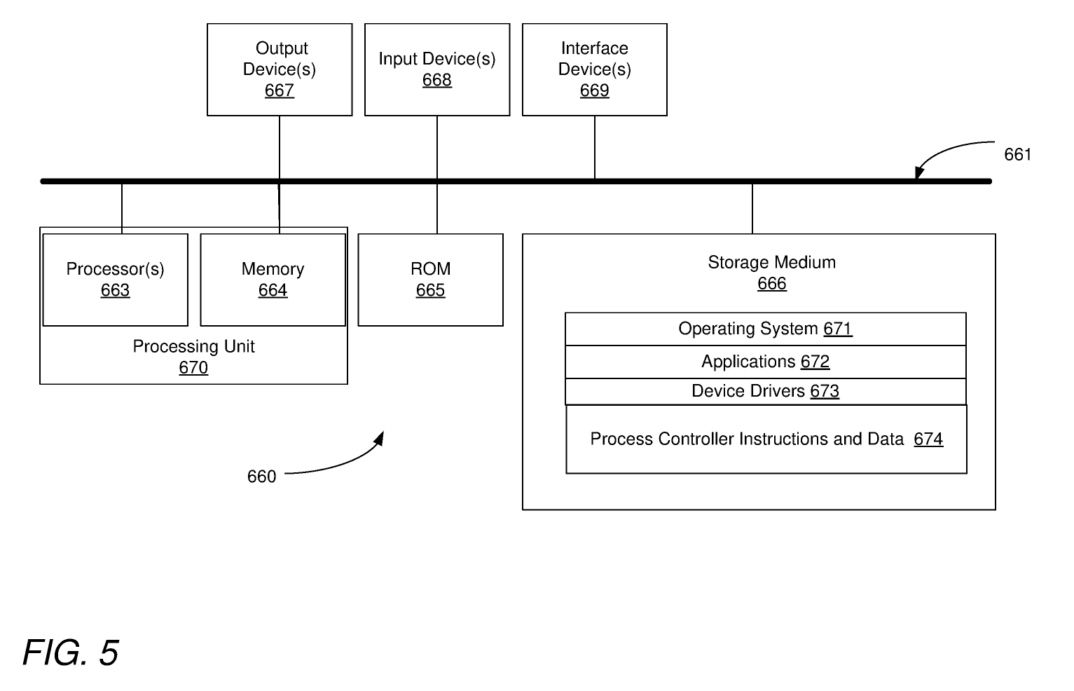

FIG. 5 is a diagram of a structure of a process controller, suitable for use as process controller 104 of FIG. 1, of a player reviewable wagering system in accordance with various embodiments of the invention. A process controller may be constructed from or configured using a set of processing devices that perform the operations of the process controller. In many embodiments, a process controller can be constructed from or configured using various types of processing devices including, but not limited to, a mobile device such as a smartphone, a personal digital assistant, a wireless device such as a tablet computer or the like, an electronic gaming machine such as a slot machine, a personal computer, a gaming console, a set-top box, a computing device, a controller, a server, or the like.

Process controller 660 includes a bus 661 providing an interface for a set of a set of processors 663, random access memory (RAM) 664, read only memory (ROM) 665, machine-readable storage medium 666, a set of player output devices 667, a set of player input devices 668, and a set of communication interface and/or network interface devices 669.

The set of processors 663 may take many forms, such as, but not limited to: a central processing unit (CPU); a multi-processor unit (MPU); an ARM processor; a programmable logic device; or the like.

Examples of output devices 667 include, include, but are not limited to: display screens; light panels; and/or lighted displays. In accordance with particular embodiments, the set of processors 663 are operatively connected to audio output devices such as, but not limited to: speakers; and/or sound amplifiers. In accordance with many of these embodiments, the set of processors 663 are operatively connected to tactile output devices like vibrators, and/or manipulators.

In the example embodiment, the set of processors 663 and the random access memory (RAM) 664 form a process controller processing unit 670. In some embodiments, the process controller processing unit includes a set of processors operatively connected to a set of of a RAM, ROM, and machine-readable storage medium; the set of processors of the process controller processing unit receive instructions stored by the set of of a RAM, ROM, and machine-readable storage medium via a bus; and the set of processors execute the received instructions. In some embodiments, the process controller processing unit is an ASIC (Application-Specific Integrated Circuit). In some embodiments, the process controller processing unit is a SoC (System-on-Chip).

Examples of player input devices 668 include, but are not limited to: tactile devices including but not limited to, keyboards, keypads, foot pads, touch screens, and/or trackballs; non-contact devices such as audio input devices; motion sensors and motion capture devices that the process controller can use to receive inputs from a player when the player interacts with the process controller 660.

The set of communication interface and/or network interface devices 669 provide a set of wired or wireless interfaces for exchanging data and commands between the process controller 660 and other devices that may be included in a player reviewable wagering system. Such wired and wireless interfaces include, but are not limited to: a Universal Serial Bus (USB) interface; a Bluetooth interface; a Wi-Fi interface; an Ethernet interface; a Near Field Communication (NFC) interface; a plain old telephone system (POTS), cellular, or satellite telephone network interface; and the like.

The machine-readable storage medium 666 stores machine-executable instructions for various components of the process controller 660 such as, but not limited to: an operating system 671; a set of applications 672; a set of device drivers 673; and player reviewable wagering system process controller instructions and data 674 for use by the set of processors 663 to provide the features of a process controller as described herein.

In various embodiments, the machine-readable storage medium 670 is one of a (or a combination of two or more of) a hard drive, a flash drive, a DVD, a CD, a flash storage, a solid state drive, a ROM, an EIEPROM, and the like.

In operation, the machine-executable instructions are loaded into memory 664 from the machine-readable storage medium 666, the ROM 665 or any other storage location. The respective machine-executable instructions are accessed by the set of processors 663 via the bus 661, and then executed by the set of processors 663. Data used by the set of processors 663 are also stored in memory 664, and the set of processors 663 access such data during execution of the machine-executable instructions. Execution of the machine-executable instructions causes the set of processors 663 to control the process controller 660 to provide the features of a player reviewable wagering system process controller as described herein.

Although the process controller 660 is described herein as being constructed from or configured using a set of processors and instructions stored and executed by hardware components, the process controller can be composed of only hardware components in accordance with other embodiments. In addition, although the storage medium 666 is described as being operatively connected to the set of processors through a bus, those skilled in the art of process controllers will understand that the storage medium can include removable media such as, but not limited to, a USB memory device, an optical CD ROM, magnetic media such as tape and disks. Also, in some embodiments, the storage medium 666 may be accessed by processor 663 through one of the interfaces or using a communication link. Furthermore, any of the player input devices or player output devices may be operatively connected to the set of processors 663 via one of the interfaces or using a communication link.

In various embodiments, the process controller 660 may be used to construct other components of a player reviewable wagering system as described herein.

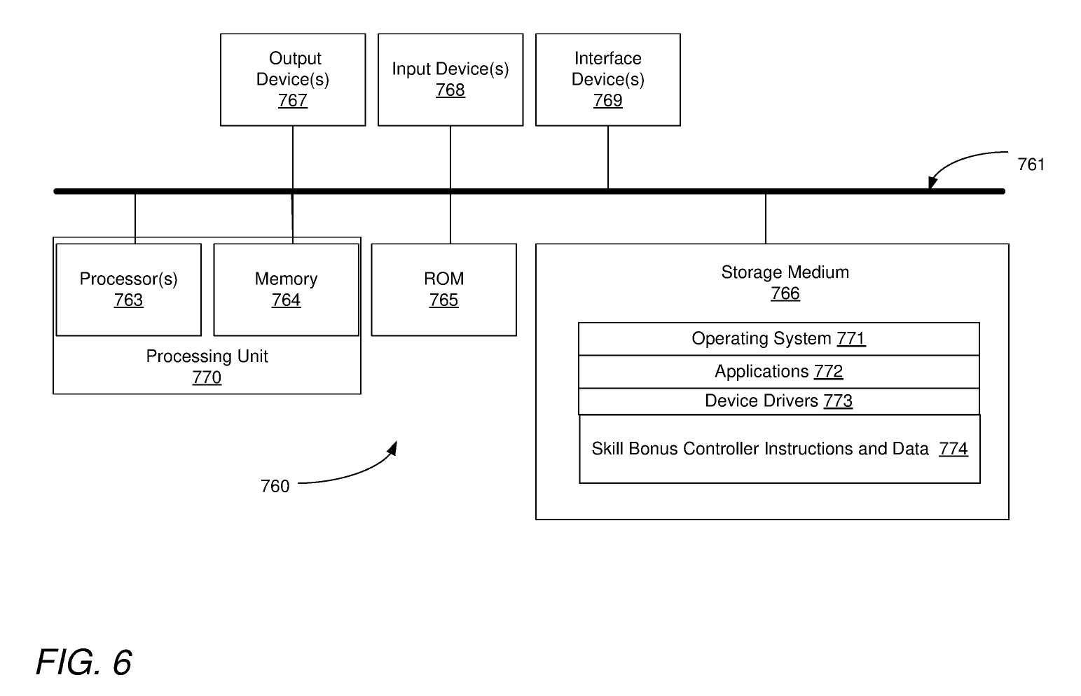

FIG. 6 is a diagram of a structure of a skill bonus controller, suitable for use as skill bonus controller of FIG. 1, of a player reviewable wagering system in accordance with various embodiments of the invention. A skill bonus controller may be constructed from or configured using a set of processing devices that perform the operations of the skill bonus controller. In many embodiments, a skill bonus controller can be constructed from or configured using various types of processing devices including, but not limited to, a mobile device such as a smartphone, a personal digital assistant, a wireless device such as a tablet computer or the like, an electronic gaming machine such as a slot machine, a personal computer, a gaming console, a set-top box, a computing device, a controller, a server, or the like.

Skill bonus controller 760 includes a bus 761 providing an interface for a set of a set of processors 763, random access memory (RAM) 764, read only memory (ROM) 765, machine-readable storage medium 766, a set of player output devices 767, a set of player input devices 768, and a set of communication interface and/or network interface devices 769.

The set of processors 763 may take many forms, such as, but not limited to: a central processing unit (CPU); a multi-processor unit (MPU); an ARM processor; a programmable logic device; or the like.

Examples of output devices 767 include, include, but are not limited to: display screens; light panels; and/or lighted displays. In accordance with particular embodiments, the set of processors 763 are operatively connected to audio output devices such as, but not limited to: speakers; and/or sound amplifiers. In accordance with many of these embodiments, the set of processors 763 are operatively connected to tactile output devices like vibrators, and/or manipulators.

In the example embodiment, the set of processors 763 and the random access memory (RAM) 764 form a skill bonus controller processing unit 770. In some embodiments, the skill bonus controller processing unit includes a set of processors operatively connected to a set of of a RAM, ROM, and machine-readable storage medium; the set of processors of the skill bonus controller processing unit receive instructions stored by the set of of a RAM, ROM, and machine-readable storage medium via a bus; and the set of processors execute the received instructions. In some embodiments, the skill bonus controller processing unit is an ASIC (Application-Specific Integrated Circuit). In some embodiments, the skill bonus controller processing unit is a SoC (System-on-Chip).

Examples of player input devices 768 include, but are not limited to: tactile devices including but not limited to, keyboards, keypads, foot pads, touch screens, and/or trackballs; non-contact devices such as audio input devices; motion sensors and motion capture devices that the skill bonus controller can use to receive inputs from a player when the player interacts with the skill bonus controller 760.

The set of communication interface and/or network interface devices 769 provide a set of wired or wireless interfaces for exchanging data and commands between the skill bonus controller 760 and other devices that may be included in a player reviewable wagering system. Such wired and wireless interfaces include, but are not limited to: a Universal Serial Bus (USB) interface; a Bluetooth interface; a Wi-Fi interface; an Ethernet interface; a Near Field Communication (NFC) interface; a plain old telephone system (POTS), cellular, or satellite telephone network interface; and the like.

The machine-readable storage medium 766 stores machine-executable instructions for various components of the skill bonus controller 760 such as, but not limited to: an operating system 771; a set of applications 772; a set of device drivers 773; and skill bonus controller instructions and data 774 for use by the set of processors 763 to provide the features of a skill bonus controller as described herein.

In various embodiments, the machine-readable storage medium 770 is one of a (or a combination of two or more of) a hard drive, a flash drive, a DVD, a CD, a flash storage, a solid state drive, a ROM, an EIEPROM, and the like.

In operation, the machine-executable instructions are loaded into memory 764 from the machine-readable storage medium 766, the ROM 765 or any other storage location. The respective machine-executable instructions are accessed by the set of processors 763 via the bus 761, and then executed by the set of processors 763. Data used by the set of processors 763 are also stored in memory 764, and the set of processors 763 access such data during execution of the machine-executable instructions. Execution of the machine-executable instructions causes the set of processors 763 to control the skill bonus controller 760 to provide the features of a player reviewable wagering system skill bonus controller as described herein.

Although the skill bonus controller 760 is described herein as being constructed from or configured using a set of processors and instructions stored and executed by hardware components, the skill bonus controller can be composed of only hardware components in accordance with other embodiments. In addition, although the storage medium 766 is described as being operatively connected to the set of processors through a bus, those skilled in the art of skill bonus controllers will understand that the storage medium can include removable media such as, but not limited to, a USB memory device, an optical CD ROM, magnetic media such as tape and disks. Also, in some embodiments, the storage medium 766 may be accessed by processor 763 through one of the interfaces or using a communication link. Furthermore, any of the player input devices or player output devices may be operatively connected to the set of processors 763 via one of the interfaces or using a communication link.

In various embodiments, the skill bonus controller 760 may be used to construct other components of a player reviewable wagering system as described herein.

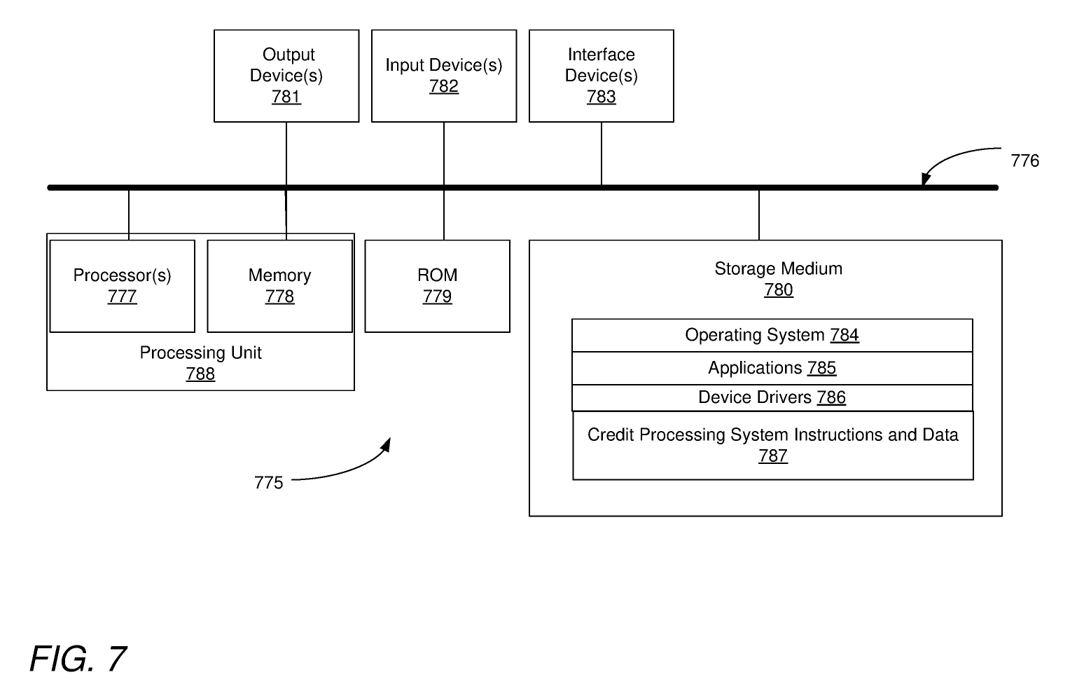

FIG. 7 is a diagram of a structure of a credit processing system, suitable for use as credit processing system 105 of FIG. 1, of a player reviewable wagering system in accordance with various embodiments of the invention. A credit processing system may be constructed from or configured using a set of processing devices that perform the operations of the credit processing system. In many embodiments, a credit processing system can be constructed from or configured using various types of processing devices including, but not limited to, a mobile device such as a smartphone, a personal digital assistant, a wireless device such as a tablet computer or the like, an electronic gaming machine such as a slot machine, a personal computer, a gaming console, a set-top box, a computing device, a controller, a server, or the like.

Credit processing system 775 includes a bus 776 providing an interface for a set of a set of processors 777, random access memory (RAM) 778, read only memory (ROM) 779, machine-readable storage medium 780, a set of player output devices 781, a set of player input devices 782, and a set of communication interface and/or network interface devices 783.

The set of processors may take many forms, such as, but not limited to: a central processing unit (CPU); a multi-processor unit (MPU); an ARM processor; a programmable logic device; or the like.

Examples of output devices include, but are not limited to: display screens; light panels; lighted displays; credit item printers and writing devices; audio output devices such as, but not limited to, buzzers, speakers and sound amplifiers; and tactile output devices like vibrators, and/or manipulators.

In the example embodiment, the set of processors and the random access memory (RAM) form a credit processing system processing unit 788. In some embodiments, the credit processing system processing unit includes a set of processors operatively connected to a set of of a RAM, ROM, and machine-readable storage medium; the set of processors of the credit processing system processing unit receive instructions stored by the set of of a RAM, ROM, and machine-readable storage medium via a bus; and the set of processors execute the received instructions. In some embodiments, the credit processing system processing unit is an ASIC (Application-Specific Integrated Circuit). In some embodiments, the credit processing system processing unit is a SoC (System-on-Chip).

Examples of player input devices include, but are not limited to: credit item reading devices such as optical and/or electromagnetic scanners; tactile devices including but not limited to, keyboards, keypads, foot pads, touch screens, and/or trackballs; non-contact devices such as audio input devices; motion sensors and motion capture devices that the credit processing system can use to receive inputs from a player when the player interacts with the credit processing system.

The set of communication interface and/or network interface devices provide a set of wired or wireless interfaces for exchanging data and commands between the credit processing system and other devices that may be included in a player reviewable wagering system. Such wired and wireless interfaces include, but are not limited to: a Universal Serial Bus (USB) interface; a Bluetooth interface; a Wi-Fi interface; an Ethernet interface; a Near Field Communication (NFC) interface; a plain old telephone system (POTS), cellular, or satellite telephone network interface; and the like.

The machine-readable storage medium stores machine-executable instructions for various components of the credit processing system such as, but not limited to: an operating system 784; a set of applications 785; a set of device drivers 786; and bonus processing system instructions and data 787 for use by the set of processors 763 to provide the features of a credit processing system as described herein.

In various embodiments, the machine-readable storage medium is one of a (or a combination of two or more of) a hard drive, a flash drive, a DVD, a CD, a flash storage, a solid state drive, a ROM, an EIEPROM, and the like.

In operation, the machine-executable instructions are loaded into memory from the machine-readable storage medium, the ROM or any other storage location. The respective machine-executable instructions are accessed by the set of processors via the bus, and then executed by the set of processors. Data used by the set of processors are also stored in memory, and the set of processors access such data during execution of the machine-executable instructions. Execution of the machine-executable instructions causes the set of processors to control the credit processing system to provide the features of a credit processing system as described herein.

Although the credit processing system is described herein as being constructed from or configured using a set of processors and instructions stored and executed by hardware components, the credit processing system can be composed of only hardware components in accordance with other embodiments. In addition, although the storage medium is described as being operatively connected to the set of processors through a bus, those skilled in the art of credit processing systems will understand that the storage medium can include removable media such as, but not limited to, a USB memory device, an optical CD ROM, magnetic media such as tape and disks. Also, in some embodiments, the storage medium may be accessed by the set of processors through one of the interfaces or using a communication link. Furthermore, any of the player input devices or player output devices may be operatively connected to the set of processors via one of the interfaces or using a communication link.

In various embodiments, the credit processing system may be used to construct other components of a player reviewable wagering system as described herein.

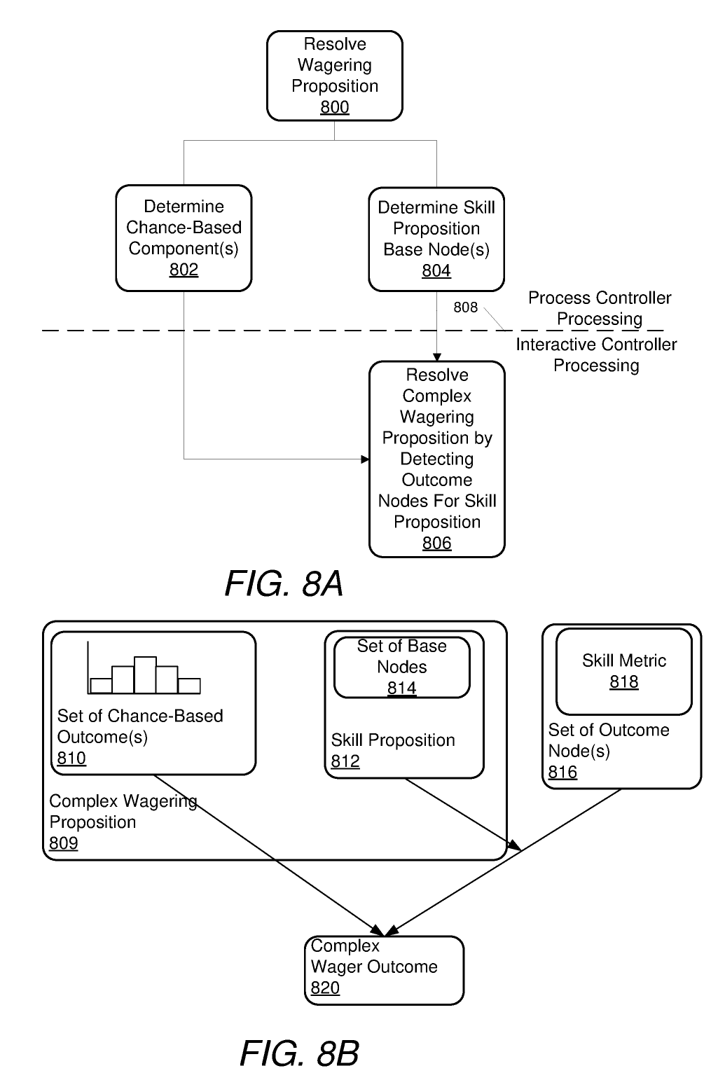

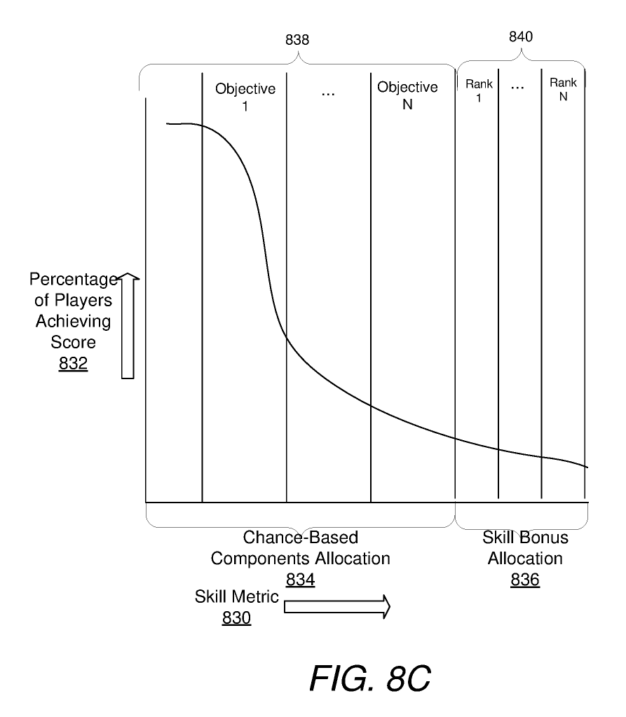

FIG. 8A is a block diagram of a process of a player reviewable wagering system during a wagering session in accordance with various embodiments of the invention. A player reviewable wagering system resolves 800 a wagering proposition by generating 802 a set of chance-based outcomes using one or more random elements. The player reviewable wagering system generates 804 portions of a skill proposition that will be presented to a set of players. The complex wagering proposition is resolved 806 by detecting a set of outcome nodes for the skill proposition and mapping the set of outcome nodes to the set of chance-based components.

In some embodiments, as indicated by dashed line 808, a process controller of the player reviewable wagering system performs processing for generating 802 the set of chance-based outcomes and generating 804 the skill proposition while an interactive controller performs processing for resolving 806 the complex wagering proposition.

FIG. 8B is a block diagram of a complex wagering proposition of a player reviewable wagering system during a wagering session in accordance with various embodiments of the invention. A complex wagering proposition 809 includes a set of chance-based outcomes 810 and a skill proposition 812 having a set of base nodes 814. The base nodes are as subset of the possible nodes within a game space and represent the nodes to which a player reviewable wagering system will transition to if a player wins the skill proposition. In other words, each of the base nodes represents an objective within the game space to be met in order for the player to be awarded credits for winning the skill proposition. During a complex wagering process, a subset of the nodes will be transitioned to and become a set of outcome nodes. A subset of the set of outcome nodes correspond to respective chance-based outcomes of the set of chance-based outcomes 810.

In an embodiment, during operation, a player reviewable wagering system presents the skill proposition to a player in a context of a skill-based game having interactive elements. As the player skillfully interacts with the interactive elements, the player reviewable wagering system detects event transitions between nodes based on the player's interactions. The event transitions correspond to transitions between nodes within the game space and the transitioned to nodes constitute a set of outcome nodes.

In many embodiments, the outcome nodes may correspond with the set of base nodes that constitute the skill proposition, that is, if a player exhibits perfect play and achieves all of the objectives of a skill proposition, the set of base nodes will be a subset of the set of outcome nodes. In imperfect play, there may be an intersection between the set of base nodes and the set of outcome nodes, but the set of base nodes are not a subset of the outcome nodes. In completely imperfect play when a player is unable to achieve even a single objective of the skill proposition represented by the set of base nodes, there may be no intersection between the set of base nodes and the set of outcome nodes, that is the intersection between the set of base nodes and the set of outcome nodes is the null set.

The player reviewable wagering system detects the event transitions to the set of outcome nodes 812 when the player is presented with the skill proposition and attempts to satisfy the skill proposition. A complex wager outcome 820 is determined on the basis of the generated set of base nodes that describe the skill proposition of the skill-based game, the detected set of outcome nodes that describe the player's achievements while attempting to satisfy the skill proposition, and the generated set of chance-based outcomes that describe amounts of credits that are awarded to a player based on the player being able to satisfy the skill proposition.

In some embodiments, a separate skill metric 818 is determined by the player reviewable wagering system and the skill metric is used to generate a skill bonus as part of the complex wager outcome for the player as described herein.

FIG. 8C is a diagram illustrating a complex wager outcome in accordance with various embodiments of the invention. In many embodiments, a complex wager outcome of an individual player utilizes an individual skill metric 830 of a player as compared to historical player skill metric data expressed as a percentage of player's achieving a score 832 of a skill metric. The individual skill metric is a value of a skill metric for an individual player. The skill metric can be any metric that is used to score a player's skillful play of a skill-based game provided by an interactive application. Historical skill metric data can be used to determine a probability that any individual player will fall within a specified skill range, thus giving a cumulative probability for player scores. Chance-based outcomes are allocated 834 to a player based on the player's individual skill metric as compared to the skill metric data collected from other players. As illustrated, one to N chance-based outcomes are awarded to the player depending on which one of one or more skill ranges or objectives 838 that the player's individual skill metric falls into. In addition, the player may be allocated a skill bonus 836 that is allocated to the player based on a percentile ranking of the player's individual skill metric. Accordingly, a complex wager outcome for a player may include credits awarded to the player based on the player's achievement of one or more skill propositions associated with one or more chance-based outcomes that are generated using a paytable and a random number generator having an output of random elements that are uniformly distributed. Each of the set of skill propositions correspond to a specified range of individual skill metrics as compared to historical skill metric data. In addition, the player may receive credits from a bonus allocated 836 to the player based on the player's individual skill metric falling with a specified range of individual skill metric percentile rankings 840.

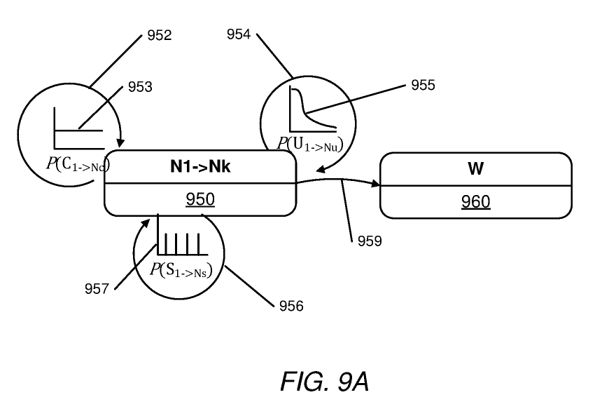

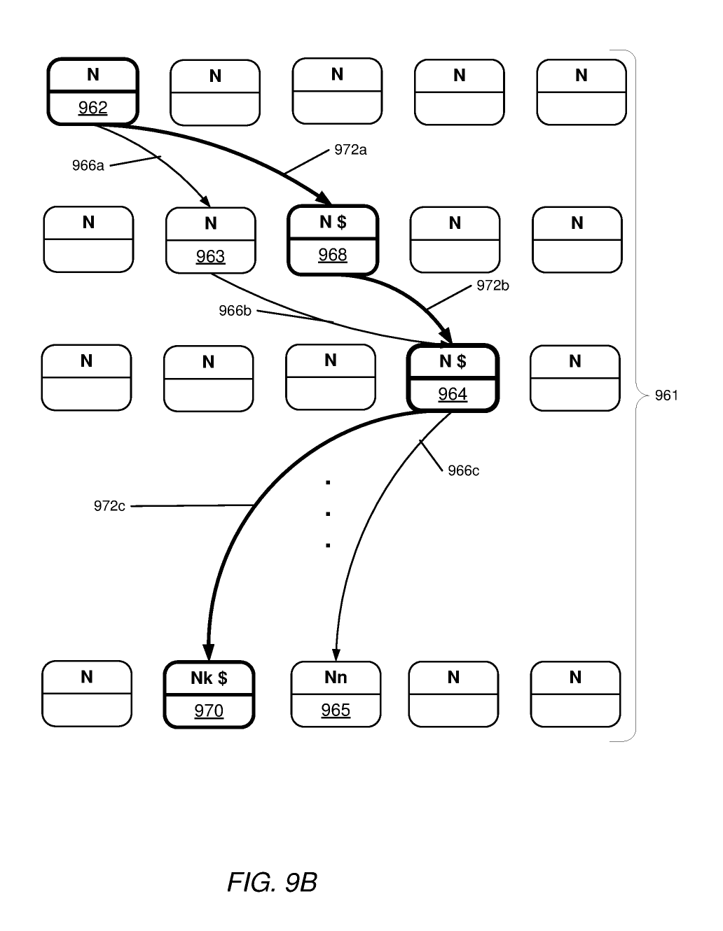

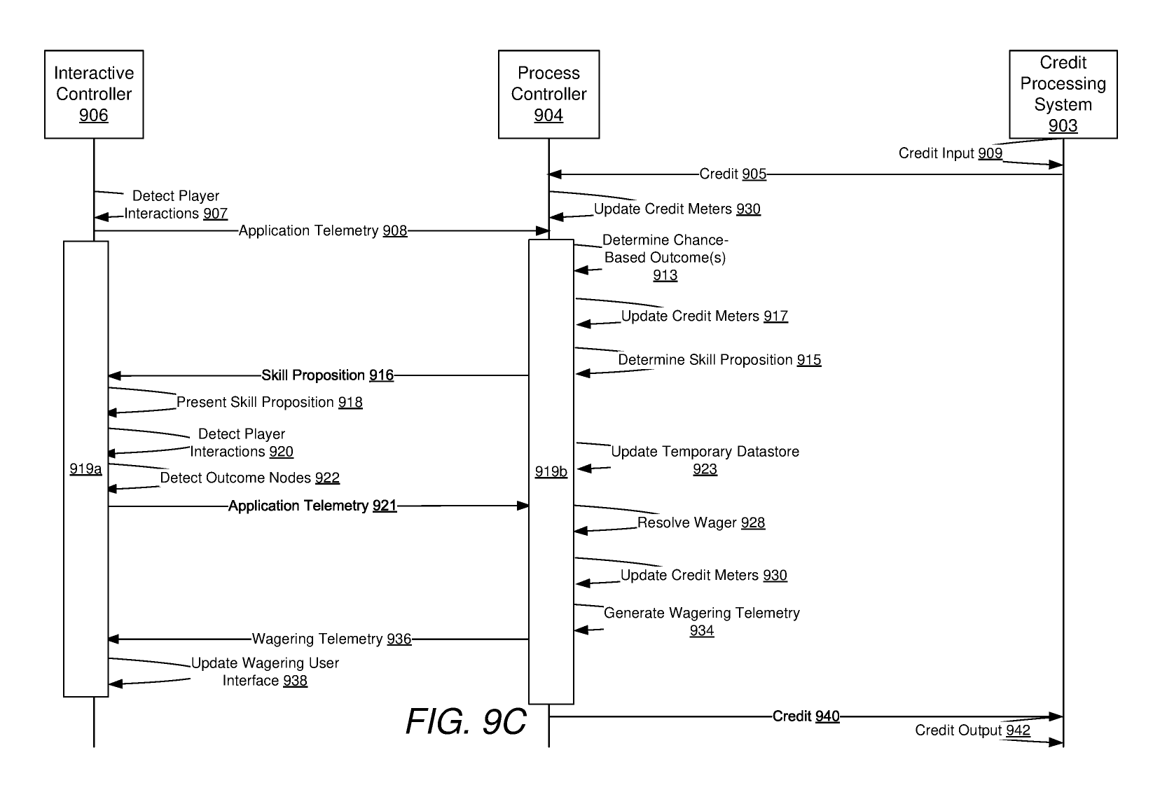

FIG. 9A is a state diagram of a wagering process in accordance with various embodiments of the invention. A wagering session includes determining a wager outcome for a wager committed by a player during one or more wagering processes. A wagering process can be described using a state diagram having an arbitrary number of states or base nodes, such as base node N1 to base node Nk 950. A transition between some of the base nodes may occur in response to events detected or generated by a player reviewable wagering system during a complex wagering process. Such a transition is herein termed an event transition. Different types and different combinations of types of events cause event transitions between base nodes of the complex wagering process.

In many embodiments, some event transitions occur independently of any player interaction with the complex wagering process and are instead transitions made by the player reviewable wagering system as a result of a random element generated by the player reviewable wagering system, such as event transition 952, where the probability that the event is generated has a known probability distribution 953.

In some embodiments, some event transitions occur based on detection of a player's interaction with the complex wagering process, such as event transition 954. Such an event transition is based upon detection by the player reviewable wagering system of an interaction by a player with an interactive element of the player reviewable wagering system. The probability that a player will interact with the interactive element to effect a particular event transition can be described using a probability distribution 955 for the player interaction.

In various embodiments, an event transition occurs as a result of detecting a player's selection made between two or more selectable interactive elements, as exemplified by event transition 956 having a discrete probability distribution 957.

At an end of a wagering process, the complex wagering process transitions 959 to an outcome node 960 and a wager outcome is generated.

FIG. 9B is another state diagram of a wagering process in accordance with various embodiments of the invention. A game space 961 includes a set of nodes. Each node represents a potential state within the game space that may be achieved as a player plays an interactive application, such as but not limited to a skill-based game, corresponding to the game space. A subset of the nodes of the game space are determined as a set of base nodes, such as nodes 962, 968, and 964, that define a skill proposition within the game space. As the player plays the skill-based game associated with the game space, the player's interactions with the transitions are detected as event transitions. For a player to successfully satisfy the skill proposition, the player's interactions and wagering system responses creates a set of event transitions that when detected by the wagering system cause the wagering system to transition between the nodes of the set of nodes, as illustrated by event transitions 972a, 972b, and 972c. As the player actually plays the skill-based game, the player's actual interactions when detected by the wagering system cause the wagering system to transition, as illustrated by event transitions 966a, 966b, and 966c, to a set of outcome nodes, as illustrated by nodes 962, 963, 964, and 965. In the illustrated embodiment, the set of base nodes include nodes 962, 968, 964, and 970, the set of outcome nodes includes nodes 962, 963, 964, and 965. The intersection between the two sets includes the nodes 962 and 964, that is, as illustrated is this example embodiment, the player has only partially satisfied the skill proposition by only being able to cause the wagering system to transition to a subset of the base nodes.

In various embodiments, a subset of the base nodes are associated with a set of chance-based outcomes (as indicated by the $ symbol in nodes 968, 964, and 970) such that, if the player is successful in satisfying the skill proposition by causing the wagering system to transition to each of the nodes associated with the set of chance-based outcomes, the player will receive an award of credits as defined by the set of chance-based outcomes. In the illustrated example embodiment, the set of outcome nodes includes only one node associated with a chance-based outcome, that is node 964. Accordingly, the player would only be awarded an amount of credits of the set of chance-based outcomes associated with node 964.

FIG. 9C is a sequence diagram of interactions between components of a player reviewable wagering system during a wagering session in accordance with various embodiments of the invention. The components of the player reviewable wagering system include a process controller 904, such as process controller 104 of FIG. 1, an interactive controller 906, such as interactive controller 102 of FIG. 1, and a credit processing system 903, such as credit processing system 105 of FIG. 1.

In some embodiments, at a beginning of the wagering session, the process includes a credit input 909 to the player reviewable wagering system with process controller 904 communicating with the credit processing system 903 to receive incoming credit data 905. The process controller 904 uses the incoming credit data to transfer credits onto a set of credit meters associated with one or more players of the player reviewable wagering system, thus transferring credits into the player reviewable wagering system and on to the set of credit meters.

In many embodiments, the interactive controller 906 detects 907 one or more players performing a player interaction in an application interface of an interactive application provided by the interactive controller 906. The interactive controller 906 communicates application telemetry data 908 to the process controller 904. The application telemetry data 908 includes, but is not limited to, the player interaction detected by the interactive controller 906.

The process controller 904 receives the application telemetry data 908. Upon detection by the process controller 904 that the player interactions included in the application telemetry data 908 indicates a wagering session 919a and 919b is to be initiated in accordance with a complex wagering proposition, the process controller 904 generates 913 one or more chance-based outcomes of the complex wagering proposition. The process controller 904 updates 917 one or more credit meters associated with the set of players based on amounts of credits wagered in the wagering event. The process controller generates 915 a skill proposition of the complex wagering proposition and communicates data of the skill proposition 916 to the interactive controller 906.

The interactive controller 906 receives the skill proposition data 916 from the process controller 904 and uses the skill proposition data 916 to generate and present 918 to the set of players a skill proposition. The presentation of the skill proposition is presented to the set of players in the user interface of the interactive application of the interactive controller 906. The interactive controller 906 detects 920 player interactions of the set of players with the presentation of the skill proposition and detects a set of outcome nodes based on the player interactions. The interactive controller 906 communicates data of the detected set of outcome nodes as part of application telemetry 921 data to the process controller 904. The process controller 904 receives the application telemetry data and updates 923 a temporary datastore with the application telemetry data 921.

In some embodiments, the skill proposition as presented to the player includes a video portion and the application telemetry data 921 includes the video portion of the skill proposition as presented to the player. In such embodiments, a video record of the wagering session is stored in the temporary datastore for later review.

The process controller 904 resolves 928 the wagering proposition by determining a complex wager outcome using the set of outcome nodes and the set of chance based wager outcomes as described herein. The process controller updates 930 the set of credit meters associated with the set of players using data of the complex wager outcome generates wagering telemetry data 934 that is communicated 936 to the interactive controller. The interactive controller 906 receives the wagering telemetry data 936 and updates 936 a wagering user interface on a partial basis of the wagering telemetry data 936.

In many embodiments, upon detecting that the wagering session 919a and 919b is completed, such as by receiving a cashout communication from one or more players of the player reviewable wagering system, the process controller 904 transfers credits off of the set of credit meters, generates outgoing credit data 940 on the basis of the credits transferred off of the set of credit meters, and communicates the outgoing credit data 940 to the credit processing system 903. The credit processing system receives the outgoing credit data 940 and generates 942 a credit output as described herein, thus transferring credits off of the set of credit meters and out of the player reviewable wagering system.

In some embodiments, at a beginning of the wagering session, the process includes an application credit input to the player reviewable wagering system with the process controller 904 communicating with the credit processing system 903 to receive incoming application credit data. The process controller 902 uses the incoming application credit data to transfer application credits onto a set of application credit meters associated with one or more players of the player reviewable wagering system, thus transferring application credits into the player reviewable wagering system and on to the set of application credit meters. The process controller 904 uses the outcome node data to generate an amount of application credit to award to a player based on the player's skillful interactions with an interactive application executed by the interactive controller 905. Upon detecting that the wagering session is completed, such as by receiving a cashout communication from a set of players of the player reviewable wagering system, the process controller 904 transfers application credits off of the set of application credit meters, generates outgoing application credit data on the basis of the application credits transferred off of the set of application credit meters, and communicates the outgoing application credit data to the credit processing system 903. The credit processing system receives the outgoing application credit data and generates an application credit output as described herein, thus transferring application credits off of the set of application credit meters and out of the player reviewable wagering system.

In some embodiments, a player reviewable wagering system has a skill bonus pool. In many such embodiments, a wager subcontroller of the process controller 904 allocates a portion of a wager or a chance-based outcome to a skill bonus pool credit meter. The wager subcontroller may take credits from the skill bonus pool as an outcome of a complex wagering proposition.

In some embodiments, the process controller determines what resources and commands to provide to the interactive controller for use by the interactive application provided by the interactive controller partially on the basis of the chance-based outcome. In some such embodiments, resources are provided in a case that the wager was a winning wager for the player. In other such embodiments, fewer or no resources are provided in a case of a losing wager.

In some embodiments, the process controller determines what resources to provide based on internal logic of the process controller. In some such embodiments, the process controller employs a random element generator, such as a random number generator, to generate a random element and the random element is used to determine what resources are provided to the interactive controller.

In several embodiments, the process controller generates an increment or a decrement of an amount of application credit using the interactions received from the interactive controller. The increment or decremented amount is communicated to the interactive controller for display to the player.

In some embodiments, the process controller executes a wager of credit as a virtual currency, application credit, interactive elements or objects. In some such embodiments, the process controller employs a random element generator, such as a random number generator, to generate a random element and the random element is used to generate a chance-based outcome in credit as a virtual currency, application credit, interactive elements or objects.

In many embodiments, a session/management controller of a player reviewable wagering system is used to store application credit for use of the player. In such an embodiment, application credit is generated by the process controller based on the player's use of the player reviewable wagering system and an amount of the application credit is communicated to the session/management controller. The session/management controller stores the amount of application credit between sessions. In some embodiments, the session/management controller communicates an amount of application credit to the process controller at the start of a session for use by the player during a session.

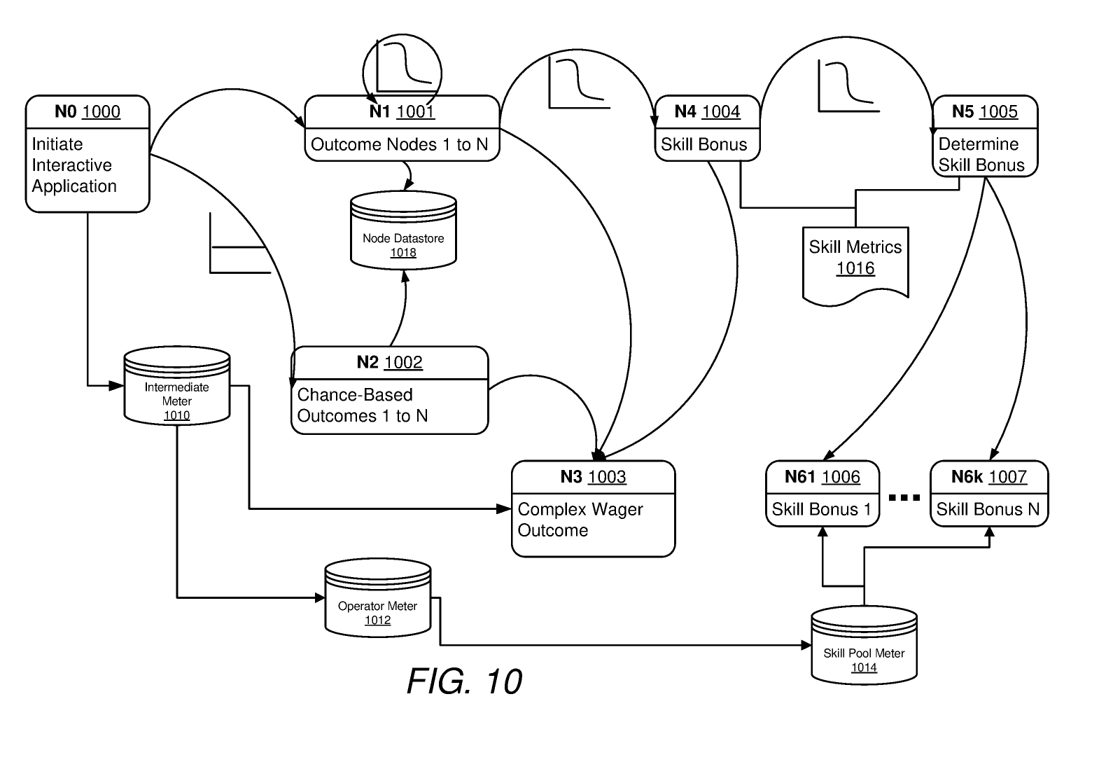

FIG. 10 is a state diagram of a wagering process of a wagering process in accordance with an embodiment of the present invention. In a state or node NO 1000, an interactive application is initiated. The interactive application provides a skill-based game to a player. As the player skillfully plays the skill-based game, a skill metric is detected for the player. In a node two N2 1002, a set of chance-based outcomes are generated by the player reviewable wagering system for a complex wagering proposition using a random number generator that generates random elements having a uniform distribution and a paytable that maps the random elements to chance-based outcomes. Each of the set of chance-based outcomes includes an associated amount of credits and each of the set of chance-based outcomes is associated with one or more base node of a set of base nodes of a skill proposition of the skill-based game. The credits associated with the set of chance-based outcomes are transferred into an intermediate credit meter 1010 pending generation of a complex wager outcome in the skill-based game. Generation of the chance-based outcomes constitute an event transition from a node in preparation for a determining a complex wager outcome to a node where generation of a complex wager outcome is pending on detection of a set of outcome nodes. On such an event transition, data of the set of chance-based outcomes are stored in the node datastore 1018.

In a node one N1 1001, the player skillfully plays the skill-based game attempting to achieve a successful set of outcome nodes for a set of base nodes of the skill proposition of the skill-based game. As the player skillfully plays the skill-based game, an individual skill metric is detected for the player indicating the player's skill at the skill-based game. A probability that the player can achieve a specific skill metric value can be described as a cumulative probability determined from skill metric data collected from other players as the other players play the skill-based game.

Each wagering proposition has a skill proposition in the form of a base game described by the set of base nodes and the base game is presented to the player as the skill proposition. The base game has multiple base nodes, namely base nodes 1 to k, representing events that occur within the base game and skill propositions that are presented to the player as part of the base game, that is, the sequence of k potential decisions/action base nodes are congruent with the skill proposition. The player may interact with n nodes of the k base nodes, that is, n<=k, of the base nodes are actually used or interacted with by the player. The k base nodes describe a base game that is configured by a process controller and executed by an interactive controller. The n nodes describe a player's session in the base game and are thus outcome nodes. The player's interactions with the base nodes are stored in a node datastore 1018 when specified events occur, such as, but not limited to, when a skill proposition is generated by the wagering system, when chance-based outcomes are generated by the wagering system, when a virtual object or non-player character associated with a skill proposition is generated by the wagering system, when a player interacts with the wagering system such as by making a player input during skillful play, collision detection between a virtual object or virtual character controlled by the player and another virtual object of within the interactive application environment, detection of an outcome node achieved by the player, detection of an outcome node indicating that the player has failed a skill proposition, and achievement by the player of a skill proposition.

In a state or node three N3 1003, the set of chance-based outcomes are allocated to the player in a complex wager outcome based on the set of outcome nodes. Credits for the amounts of credits associated with the chance-based outcomes are provided from the intermediate credit meter 1010. Any credit amounts associated with unachieved skill propositions are transferred to an operator credit meter 1012 as part of the operator's gross gaming revenue. A portion of the credits in the operator credit meter 1012 are provided to a skill bonus pool credit meter 1014 for use in providing a skill bonus as described herein.

In a state or node four N4 1004, a determination is made of whether or not the player's skillful play of the skill-based game, as measured by the player's individual skill metric, indicates that the player should be awarded a skill bonus. A probability that the player's skillful play as measured by the individual skill metric will result in a skill bonus being awarded the player can be determined from a cumulative probability distribution determined from historical player skill metrics collected as other players skillfully play the skill-based game.

In a state or node five N5 1005, a specific one of one or more skill bonuses, represented by states or nodes six one N61 1006 to six N N6N 1007, is determined for a player based on the player's individual skill metric and a comparison to the historical skill metrics of the other players. Credits awarded to the player in the skill bonuses are provided from the skill bonus pool meter 1014.

In an embodiment, if an amount of credits awarded to a player as the complex wager outcome is less than an amount of credits wagered by the player then a skill bonus greater than the amount of credits is awarded to the player.

In an embodiment, the skill-based game generates a skill metric for a player that can be described by a monotonically increasing function. As the player's individual skill metric increases in value, the player is deemed to have achieved a skill proposition when the player's individual skill metric reaches a specified threshold associated with the skill proposition. Whether or not the player is awarded a skill bonus is determined if the player's individual skill metric has achieved a specified threshold percentile ranking as compared to the historical skill metric data. A specific skill bonus awarded to the player is generated on the basis of the player's individual skill metric falling within a specified range of percentile rankings.

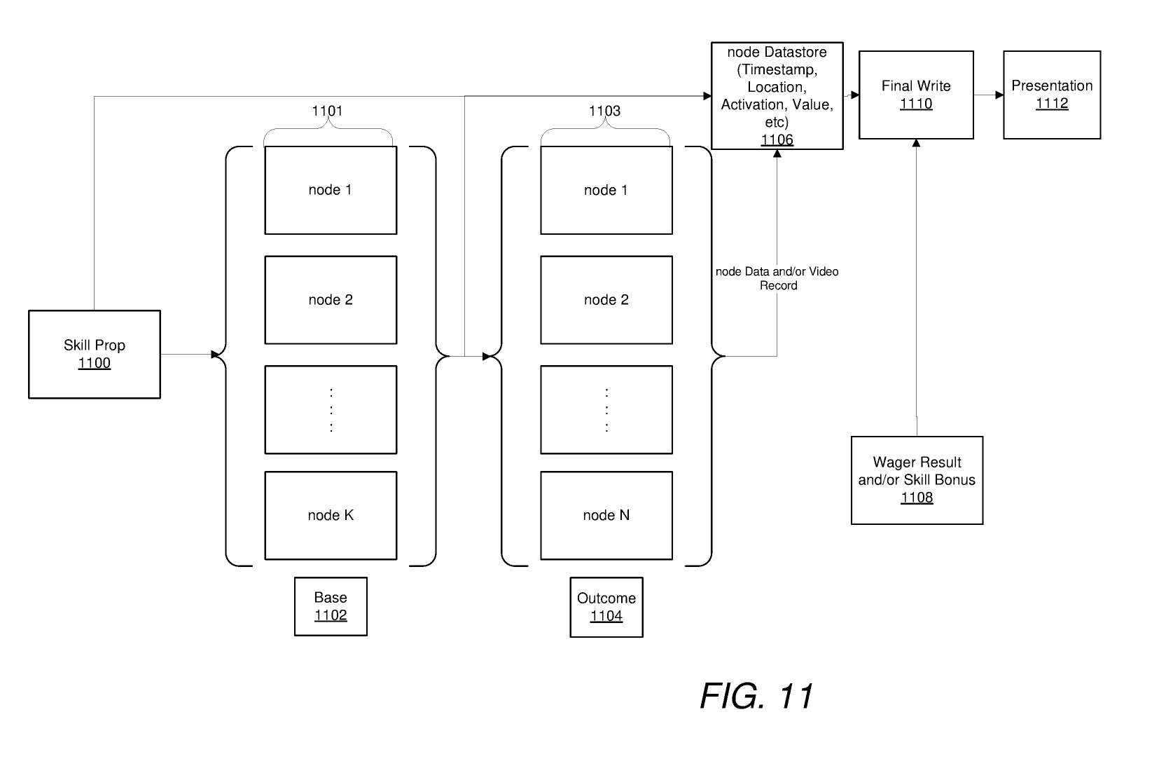

FIG. 11 is a data flow diagram of a player dispute resolution process in accordance with an embodiment of the invention. As illustrated, a wagering proposition has a skill proposition 1100 in the form of a set of base nodes 1101 of a base game 1102 that is presented to a player. The base game has multiple base nodes, namely base nodes 1 to k, representing states and events that occur within the base game and skill propositions that are presented to the player as part of the base game, that is, the sequence of k potential decisions/action base nodes are congruent with the skill proposition. The player may interact with n nodes 1103 of the k base nodes, that is, n<=k, of the base nodes are actually used or interacted with by the player. The k base nodes describe the base game that is configured by a process controller and executed by an interactive controller. The n nodes describe a player's session in the base game and are thus outcome nodes 1104. The player's interactions with the base nodes are stored in a datastore 1106 when specified events occur, such as, but not limited to, when a skill proposition is generated by the wagering system, when a virtual object or non-player character associated with a skill proposition is generated by the wagering system, when a player interacts with the wagering system such as by making a player input during skillful play, collision detection between a virtual object or virtual character controlled by the player and another virtual object of within an interactive application environment, achieving a skill proposition by collecting a virtual object, failing a skill proposition by failing to avoid a virtual object, and achievement by the player of a skill proposition.

In an embodiment, each wagering session is recorded in its entirety and a specified number of game sessions are kept in a datastore. In an example embodiment, 1000 game sessions are kept in a datastore.

In another embodiment, the skill proposition is written to a temporary datastore. During the game session, the attributes of the n interacted with nodes are written to the temporary datastore as n outcome nodes. In an example embodiment, attributes of an outcome node include a timestamp of when the player interacted with the corresponding base node, a set of values representing what kind of interaction the player had with the base node, and a location within an interactive application environment where the interaction took place.

In an example embodiment a base game is a first person shooter interactive video game where skill propositions include shooting virtual targets located throughout a 3 dimensional (3D) interactive application environment of the base game. The player may shoot the virtual targets with a virtual gun to destroy the virtual targets. A single well placed shot will destroy a target whereas a poorly placed shot will require at least one more additional shots to destroy the virtual target. Each target of the base game is represented by a base node having at least the attributes of an identification of the target and a location within the 3D interactive application environment. Each time the player interacts with a target, an outcome node is generated having an identifier of the virtual target that was interacted with, and event transition data including but not limited to a timestamp indicating when the player interacted with the virtual target, a location of the virtual target within the 3D interactive application environment, and how many shots were needed to destroy the virtual target.

In some embodiments, a full video record of a player's interactions with a skill proposition presentation is written to the datastore.

In various embodiments, data of the skill proposition, event transitions, and outcome nodes (both outcome node data and full video) combined give a comprehensive, step-by-step summary of a game session and a player's interaction with the base game.

In some embodiments, data of the the skill proposition, event transitions, base nodes, and outcome nodes (currently in temporary write file) are written to a final write datastore 1110. In various embodiments, data of a wager result and skill reward 1108 are also stored in the final datastore.

In some embodiments, data of the data session is communicated to the player through a graphical presentation 1112 of the game session. In an example embodiment, a Cartesian plot detailing the 3D game space and the player's path through the 3D game space is shown in a top-down projection. The top-down projection includes displayed data of the base nodes and outcome nodes. In addition, a succession between the outcome nodes are connected based on the time stamp data of the outcome nodes to indicate the sequence of the player's interaction with the base game.

In some embodiments, the conveyed data to the player and the corresponding wager and outcome nodes may deter players from disputing a wagering proposition outcome.

In another embodiment, templates are used to organize the outcome node data. In an example embodiment, a template is formed that is “overlaid” on a interactive application environment of a base game whereby points of review interest are tagged. The interactive controller, application control interface, or process controller generates a data packet including relevant data (screen captures, video segments, various meters, player balance, wager, etc.) every time one of these points of review are reached in the game play session to this review sub-system which accumulates it in a datastore such as a database. A set of pre-defined data is captured and placed into the replay buffers while the template of review tags connects to a UI where the review interest events are thumbnail images created from the screen captures, and whereby a player or operator staff can go through the thumbnail images to find the activity of interest. Once the particular thumbnail image is selected, a display of the relevant data is displayed.

In another embodiment, a notification method is utilized. An interactive controller application control interface and/or process controller issues notifications of all event transitions in a base game that relate to a wager and a wager outcome. A review sub-system of the process controller captures all this data and stores the data into a datastore such as a memory buffer. The review sub-system also has a set of scripting or other program instructions that determine what to extract from the datastore for replay. Data is pulled from the database and sent to a replay unit having a user interface which would either display: (a) thumbnail images of key events review interest events whereby a player or operator staff can go through the thumbnails to find the activity of interest, once the particular thumbnail image is selected, a display of the relevant data (screen caps, video segment, various meters, player balance, wager, etc.) is displayed; or (b) there is a continuous running video or image record with a playback bar that the player uses to control playback whereby a player can skip along through the record and watch what happened throughout the play session. In some embodiments, there would be several of these video records, so the last N plays could be reviewed in entirety. When a player or operator pauses the video record, or automatically, certain meters and other relevant data is displayed in addition to the video bar, making it possible to see what happened with the wager throughout the record.

In many embodiments, a user interface is provided that the player can access directly without operator intervention.

In an example embodiment, the skill-based game is a side scrolling infinite runner game (interactive application) wherein a player guides a player character through a virtual factory filled with interactive elements in the form of virtual objects that the player is to interact with, such as by avoiding, interacting with, and/or collecting the virtual object (game space having multiple states or nodes). A skill proposition generated by the player reviewable wagering system includes one or more mission objectives (set of base nodes) for the player to achieve while guiding the player character through the virtual factory. The mission objectives include, but are not limited to, avoiding a specified number of specified virtual objects, collecting a specified number of specified virtual objects, interacting in a specified manner with a specified number of a specified object, etc. Each mission objective is associated with a respective amount of credits (set of chance-based components) to be awarded to the player on achieving each respective mission objective. During a wagering session, the player reviewable wagering system generates the virtual objects associated with the mission objectives (presentation of the skill proposition) and the player attempts to successfully interact (event transition) with the virtual objects in the specified interaction (transition to an outcome node). As the virtual objects are generated and the player attempts the appropriate interactions, the player's interactions and success or failures are detected and recorded as a set of outcome nodes. If the player successfully completes a mission objective (there is an intersection between the set of outcome nodes and the set of base nodes), the player is awarded a respective amount of credits (resolved complex wager outcome). If the player disputes an amount of credits awarded, then the set of outcome nodes are recalled from the datastore and presented to the player as a sequence of interactions (wagering session review presentation) illustrating that the player did or did not successfully complete a mission objective (base node).

While the above description may include many specific embodiments of the invention, these should not be construed as limitations on the scope of the invention, but rather as examples of embodiments thereof. It is therefore to be understood that the invention can be practiced otherwise than specifically described, without departing from the scope and spirit of the invention. Thus, embodiments of the invention described herein should be considered in all respects as illustrative and not restrictive.

What is claimed:

1. A player reviewable electronic gaming machine, comprising:
an interactive controller constructed to:
provide a presentation of a skill proposition of an interactive application to a player;
detect an event transition in the interactive application to an outcome node; and
communicate data of the outcome node to a process controller; and
the process controller communicating with the interactive controller wherein the process controller is constructed to:
receive the data of the outcome node;
store the data of the outcome node in a datastore;
generate a wagering session review presentation of the outcome node using the data of the outcome node stored in the datastore; and
display the wagering session review presentation to the player.

2. The player reviewable electronic gaming machine of claim 1, wherein the interactive controller and the process controller are constructed from a same device.

3. The player reviewable electronic gaming machine of claim 1, further comprising:
an enclosure constructed to mount:
a player input device operatively connected to the interactive controller;
a player output device operatively connected to the interactive controller;
a credit input device operatively connected to the process controller; and
a credit output device operatively connected to the process controller

4. The player reviewable electronic gaming machine of claim 3, further comprising a random number generator,
wherein the process controller is further constructed to:
communicate with the credit input device to receive credit data;
credit a credit meter with credits based on the credit data;
generate a chance-based outcome of credits based on a random element generated by the random number generator;
generate a complex wager outcome using the data of the outcome node and the chance-based outcome;
update the credit meter on the basis of the complex wager outcome; and
communicate with the credit output device to generate a credit output based on credits transferred off of the credit meter, and
wherein the interactive controller is further constructed to:
detect player interactions with interactive elements of the interactive application using the player input device; and
detect the event transition associated with the outcome node based on the player interactions.

5. A player reviewable electronic gaming machine, comprising:
a processor; and
a machine-readable storage medium operatively connected to the processor, the machine-readable storage medium storing executable instructions that when executed by the processor cause the processor to:
provide a presentation of a skill proposition of an interactive application to a player;
detect an event transition in the interactive application to an outcome node;
store the data of the outcome node in a datastore;
generate a wagering session review presentation of the outcome node using the data of the outcome node stored in the datastore; and
display the wagering session review presentation to the player.

6. The player reviewable electronic gaming machine of claim 5, further comprising:
an enclosure constructed to mount:
a player input device operatively connected to the interactive controller;
a player output device operatively connected to the interactive controller;
a credit input device operatively connected to the process controller; and
a credit output device operatively connected to the process controller

7. The player reviewable electronic gaming machine of claim 6, further comprising a random number generator,
wherein the executable instructions when executed further cause the processor to:
communicate with the credit input device to receive credit data;
credit a credit meter with credits based on the credit data;
generate a chance-based outcome of credits based on a random element generated by the random number generator;
detect player interactions with interactive elements of the interactive application using the player input device; and
detect the event transition associated with the outcome node based on the player interactions;
generate a complex wager outcome using the data of the outcome node and the chance-based outcome;
update the credit meter on the basis of the complex wager outcome; and
communicate with the credit output device to generate a credit output based on credits transferred off of the credit meter.

8. A method of a player reviewable electronic gaming machine, comprising:
providing a presentation of a skill proposition of an interactive application to a player;
detecting an event transition in the interactive application to an outcome node;
storing the data of the outcome node in a datastore;
generating a wagering session review presentation of the outcome node using the data of the outcome node stored in the datastore; and
displaying the wagering session review presentation to the player.

9. The method of a player reviewable electronic gaming machine of claim 8, further comprising:
communicating with a credit input device to receive credit data;
crediting a credit meter with credits based on the credit data;
generating a chance-based outcome of credits based on a random element generated by a random number generator;
detecting player interactions with interactive elements of the interactive application using the player input device; and
detecting the event transition associated with the outcome node based on the player interactions;
generating a complex wager outcome using the data of the outcome node and the chance-based outcome;
updating the credit meter on the basis of the complex wager outcome; and
communicating with a credit output device to generate a credit output based on credits transferred off of the credit meter.
